(19) United States
(12) Patent Application Publication
(10) Pub. No.: US 2025/0337701 A1
(43) Pub. Date: Oct. 30, 2025

(54) MANAGING INTERACTIONS WITH MULTIPLE ARTIFICIAL INTELLIGENCE CHATBOTS

(71) Applicant: MicroStrategy Incorporated, Vienna, VA (US)

(72) Inventors: Yang Du, Hangzhou City (CN); Wei Jiang, Hangzhou City (CN); Darren Holmblad, Arlington, VA (US); En Li, Hangzhou, Zhejiang Province (CN); Haocan Xu, Hangzhou City (CN); Shu Liu, Hangzhou City (CN); Yuankun Li, Hangzhou City (CN); Zhongfang Zhou, Vienna, VA (US); Kai Wang, Hangzhou, Zhejiang Province (CN); Zhao Sheng, Vienna, VA (US); Ananya Ojha, Dunn Loring, VA (US); Jeffrey Clay Courcelle, Atkinson, NH (US)

(21) Appl. No.: 19/192,183

(22) Filed: Apr. 28, 2025

Related U.S. Application Data
(60) Provisional application No. 63/640,110, filed on Apr. 29, 2024.

(51) Int. Cl. H04L 51/02

(52) U.S. Cl. CPC H04L 51/02

(57) ABSTRACT

Methods, systems, and apparatus, including computer-readable media, for managing interactions with multiple artificial intelligence chatbots. In some implementations, a text input from a user is received. The system identifies multiple chatbots that the user is authorized to access, and the system selects a subset of the multiple chatbots based on the text input from the user. The system provides the text input from the user to each of the chatbots in the subset to generate a response to the text input from each of the chatbots in the subset. The system provides an output response to the text input from the user for presentation at the user device, where the response is based on one or more of the responses generated the chatbots in the subset.

### CROSS-REFERENCE TO RELATED APPLICATIONS

This application claims the benefit of priority to U.S. Provisional Patent Application No. 63/640,110, filed on Apr. 29, 2024, the entire contents of which are incorporated by reference herein.

### BACKGROUND

The present specification relates to techniques for managing applications, interfaces, and modules that leverage artificial intelligence and machine learning.

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users.

### SUMMARY

In some implementations, a computer system provides an agent or interface that can act as an intermediary or manager for multiple artificial intelligence or machine learning (AI/ML) applications or models. The agent or interface can provide a unified or centralized interface for a user to access any or all of a diverse set of AI/ML tools. The agent or interface can have the capability to automatically select which AI/ML tools are appropriate for a user's task or context, so the user does not need to manually specify which of the available AI/ML tools should be used. The agent or interface can then interact with one or more of the AI/ML tools that the agent or interface selects, and provide a result to the user. The result can be an aggregation or combination of responses from different AI/ML tools, so the agent or interface provides information from multiple AI/ML tools in a response to a single user request.

For example, a user may be granted access to several AI/ML chatbots, each with different capabilities, domains, or datasets with which to provide responses. The agent or interface can be positioned between a user and various AI/ML chatbots, so that the agent or interface distributes a user's question to multiple AI/ML chatbots. The agent or interface can evaluate and process the responses from multiple AI/ML chatbots, to provide the user with a concise, relevant result that combines useful information from multiple AI/ML chatbots.

Based on user interactions and feedback, the agent or interface can learn over time which chatbots are most appropriate for different types of user requests (e.g., for user queries in specific domains or with particular keywords). For example, the agent or interface may include an AI/ML model that is trained to select which of various AI/ML chatbots are most relevant for particular topics, contexts, user groups, keywords, and so on. The agent or interface can then selectively distribute or route user requests to the AI/ML chatbots that the agent's model indicates as most likely to be relevant to the user's request. A single user request to the agent can be distributed to multiple AI/ML chatbots that the agent predicts to be relevant, and the agent can filter or combine the responses from different AI/ML chatbots to provide a high-quality result that may seamlessly combine information from different AI/ML chatbots.

The agent or interface also increases efficiency by using a trained AI/ML model or other techniques to predict which subset of AI/ML chatbots are relevant for different requests or contexts. By predicting which subset of AI/ML chatbots is relevant, and by limiting the number of AI/ML chatbots that a user question is distributed to, the agent or interface limits the power consumption and computational demands for obtaining responses. The agent or interface can select a specific AI/ML chatbot, or a specific subset of AI/ML chatbots, that are most likely to provide the requested information. The selections can be informed by the examples of previous user questions and the AI/ML chatbots selected for those questions. For example, the system can obtain feedback from users about the answers the agent provides, and thus the set of chatbots the agent selected. The user feedback can be explicit (e.g., through user ratings, survey answers, quality rankings, etc.) or implicit (e.g., positive interaction such as sharing, saving, and otherwise using responses; negative interactions such as repeating or rephrasing a question when dissatisfied with a response, dismissing a response, abandoning or closing an interface, requesting a specific model or chatbot, etc.). Based on the user feedback, the agent can learn to select AI/ML chatbots or other AI/ML tools that are appropriate to a user's request and can provide a relevant or effective response. In many cases, the appropriate AI/ML chatbot(s) to answer a user's question will be the one that the user feedback indicates to have provided effective answers for similar questions (e.g., questions with the same topic, domain, keywords, contexts, etc.).

In general, as artificial intelligence and machine learning becomes more and more common, users have increasing numbers of different AI/ML tools, many of which may be focused on limited or specialized domains. As users gain access to more and more AI/ML models and chatbots, users are more likely to become overwhelmed, unable to identify the particular chatbot that is relevant, or unable to find a navigation path to an interface to access to that particular chatbot. Accessing the right AI/ML model or chatbot at the right time becomes more difficult for users as the number of options increases. In many cases, it takes many clicks or interactions for a user to reach an interface for interacting with a chatbot, and even then there may be many different chatbots accessible to a user. It may not be clear to the user which of various chatbots are most appropriate to answer a particular type of question that the user has. When the user has to review and select specific chatbots, this increases the complexity of the interface that the user must navigate, requires additional knowledge or experience by the user, and increases the amount of time and number of interactions before a user can obtain an answer. In addition, if the user's selection is initially incorrect, the user may need to serially ask the question to several different chatbots, further increasing the time required to provide the user an answer. Also, when a user asks questions to the wrong chatbots (e.g., chatbots that do not have the capability or dataset to provide the information requested), the requests cause computationally intensive processing that is unnecessary and inefficient.

The agent can increase effectiveness and efficiency in managing AI/ML chatbots in phases. The agent can start with a conservative query routing strategy that is very inclusive, potentially sending each user query to all chatbots that are available to the user. This helps generate many examples of query and response pairs, across a wide variety of chatbots, which can be used as training data to refine the selections of the agent. The agent uses the large number of query instances as examples of how users interacted (e.g., query content), how the chatbot behaved (e.g., the chatbot's response or answer), and the user feedback (e.g., thumbs up or down, rating score, implicit user actions upon viewing the response). The agent then learns, over time, to more selectively provide queries to subsets of the available chatbots, based on the syntax, terminology, context, and other factors in or associated with the query.

The agent can learn from examples taken from interactions of many different users, such as a set of users in a company or enterprise setting, which helps build a robust set of training examples quickly and across many different use cases. This helps the agent obtain a good understanding of the typical or default set of chatbots to use, at least for the most common types of queries. In addition, or as an alternative, the agent can learn the preferences of individual users specifically, using training data examples from each particular user's history and from the feedback of each particular user. Over time, the agent learns the quality of the chatbots or other sources and how well different chatbots respond to different types of queries.

In some implementations, a computer system provides functionality for creating and distributing customized interactive applications, such as chatbots, that provide responses using artificial intelligence or machine learning (AI/ML) models, such as large language models (LLMs). For example, the computer system can provide an interface through which a user, such as an administrator, can create or edit an interactive application. The computer system can provide an initial base application or template that includes the core functionality that enables users to obtain content from an AI/ML model. The administrator can use the interface customizations that alter the appearance and behavior of the interactive application, so the customized application provided to users will operate as the administrator intends. The customizations can include, for example, specifying the data sources available to be used in responding to user prompts (e.g., questions or statements input to a chatbot), as well as whether information from the Internet or other external sources can be used in generating responses. The interface also allows the administrator to set user access control and usage limits for the interactive application, to control resource consumption and costs incurred by repeated inference processing using AI/ML models.

After the administrator customizes the interactive application using the interface, the computer system saves the interactive application (e.g., as a new or updated chatbot) and makes the application available to other users. For example, the computer system can send hyperlinks or invitation messages to users, so the users can access a customized chatbot through a web page or web application. As another example, the computer system can include code to integrate the customized chatbot into an existing web page or web application (e.g., as an embedded item, in an iFrame, etc.). As another example, the computer system can integrate with document libraries, file browsers, document viewers, web browsers, or other types of user interfaces. As a result, the customized chatbot can be made available through any of various enterprise software platforms and applications. The interface of the customized chatbot can then be invoked by interacting with an icon or menu item for the customized chatbot, or by entering a user prompt into a text entry field of a user interface. In some implementations, the interface of the chatbot can be provided together with a document viewer, for example, in a sidebar or tab shown concurrently with the document viewer interface. This arrangement can enable the user to view a document, such as a dashboard related to a dataset, while concurrently having a conversation with a customized chatbot designed to answer questions about the dataset.

The computer system enables interactive applications to be tailored or targeted for specific data sets. For example, each interactive application that is created or customized can provide responses with information derived from a corresponding data set specified by the administrator, such as a private data set (e.g., a database table, a data cube, a spreadsheet, etc.). The system enables administrators to create and deploy multiple interactive applications concurrently. For example, different chatbots that have different behavior tailored for different sets of users. Similarly, different chatbots can be configured to provide data from different source data sets. Administrators can create and deploy different instances of chatbots and other interactive applications, each with customized behavior, appearance, and other characteristics as appropriate for their respective data sets and users.

The computer system enables administrators to customize AI/ML-enabled chatbots very quickly, without the need to re-train an AI/ML model. In particular, after specifying the customizations for the chatbot, no model training is needed and so the customized chatbot can be used right away. The system can provide a preview interface or test interface that enables an administrator to change chatbot settings and try out the updated chatbot in the generation or editing interface, to see the effects of changes in real time or near real time. To facilitate customizability and the rapid generation of chatbots, the customizations to the chatbot can be made outside the training state of the AI/ML chatbot itself, for example through the selection of which existing AI/ML model(s) to be used, which dataset(s) being used, which portions of a dataset are accessible, and the parameters or characteristics of interactions with the AI/ML model(s). Customizations can also be implemented in operations of a non-AI/ML processing system, for functions such as access control, precision or granularity of data access, and so on. With the ability to provide customized chatbots without the need to train or re-train AI/ML models, the system allows rapid generation and deployment of chatbots with minimal up-front computing resources and no training delay.

The computer system can support interactive applications where processing tasks for responding to a user prompt are split between non-AI/ML or non-probabilistic data processing systems AI/ML models (e.g., database management systems) and AI/ML models. For example, when a user prompt such as a natural language query is received, the computer system can use a database system to generate a set of result data that is relevant to the user prompt. The set of result data can then be processed using one or more AI/ML models, such as a large language model, to generate content to present in a response to the user. This system can combine the strengths of AI/ML models and non-AI/ML processing systems to provide a chatbot or other application with responses that are more complete, accurate, and reliable than either type of processing system on its own.

In general, many AI/ML models have excellent generative capabilities and the ability to produce high-quality natural language output. However, AI/ML models also often have significant limits. For example, AI/ML models typically use probabilistic processing, which may generate responses that are generalized or approximate, and so may not adequately answer a user's question or may lack the accuracy or precision needed. In some cases, AI/ML models provide content that includes hallucinations or other information that may be statistically plausible given training data but is actually factually incorrect. The probabilistic nature of AI/ML models can also result in the same user prompt resulting in significantly different responses at different times, which can decrease users' confidence and ability to rely on the responses. For example, the same question may yield different numerical answers when the question is asked multiple times to an AI/ML model, even when the source data set has not changed.

As discussed further below, the computer system can provide chatbots and other interactive applications that combine the advantages of AI/ML models and the reliability and accuracy of other non-AI/ML or non-probabilistic data processing systems, such as relational database systems. Database management systems and other systems can reliably provide result data that is accurate and reliable, calculated from the source data using proven and validated processes. For example, data processing systems can be used to search a data set and make calculations, perform aggregations, and generate values in a data series in a repeatable or deterministic manner. This can be done even over large data sets, which may be much larger than an AI/ML system can accept as input context. In addition, the processing can be focused on the specific data set of interest, without extraneous data influencing the calculations as might occur in the probabilistic processing of an AI/ML model trained on large quantities of other data.

When the interactive application is used to respond to a user prompt, the non-AI/ML data processing system (e.g., a database management system) generates result data relevant to the user prompt (e.g., user's question) from the source data set. The user prompt and the result data set, potentially with other information and context, can be provided to the AI/ML model to generate text output for the response to the user. For example, the computer system can send a request for the AI/ML model to summarize the result data set or to generate a response to the original user prompt from the result data set that has been generated. As a result, the text that the AI/ML model generates can draw from values calculated accurately from the source data set, without requiring the AI/ML model to be capable of generating those values itself or without the AI/ML model even accessing the data set. As a result, the output to the user combines the reliable, accurate calculations from the non-AI/ML system with the text and other information provided by the AI/ML model from the result data set.

Combining the processing of AI/ML systems and non-AI/ML systems in the chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying dataset that the chatbot is based on. Indeed, in many cases, the AI/ML model does not receive even portions of the actual dataset, and instead receives only metadata describing the general contents and/or structure of the data set (e.g., types of metrics and attributes, semantic meaning of the columns, etc.) and potentially sample data (e.g., fictitious examples that illustrate the type of content in the dataset without revealing the actual values and records). In addition to enhancing privacy, this also increases speed and reduces network transfer requirements, since the dataset does not need to be sent over a network and the dataset itself does not need to be processed by the AI/ML model. The process also allows the data processing system (e.g., an enterprise database management system) to reliably apply security policies and access control over the dataset that the AI/ML model typically would not be capable of applying. After the data processing system performs processing to generate a result data set, the AI/ML model is provided the result data set and asked to generate a summary. In this interaction, the AI/ML model receives the result data set that generally includes aggregated or composite information specifically answering the user's question, and the AI/ML model does not receive access to the underlying dataset itself. As a result, the system avoids granting the AI/ML model—and any third-party providing the AI/ML model as a service—access to portions of the dataset that are not appropriate for answering the current question.

The customizations that the administrator set in creating or customizing the chatbot can be used to alter the operation and results of the non-AI/ML data processing system, the AI/ML model, the front-end interface that the user sees, or a combination of any or all of them. For example, the customizations that the administrator selects can specify which dataset(s) to use when answering questions, whether additional public datasets or the Internet can be used to answer questions, which portions (e.g., columns, rows, data types, etc.) of datasets can be accessed, and so on. In addition, the customizations that the administrator selects can specify output characteristics for the chatbot such as the style, formatting, media type (e.g., text, images, text and images, etc.), and other properties of answers.

In some implementations, the customized chatbots can be configured to generate visualizations in response to questions and other user prompts. These visualizations can also be generated through a combination of processing by AI/ML models and non-AI/ML processing systems. For example, if a user prompt requests a visualization or if a visualization is otherwise appropriate for a response, the AI/ML model can specify the type of visualization (e.g., bar chart, line graph, pie chart, etc.) and other properties (e.g., data series shown, scale and data on the axes, etc.). The actual values to be displayed in the visualization, however, can be calculated by the non-AI/ML processing system, using reliable and accurate calculations from the data set. As a result, the AI/ML system can design and format a visualization appropriate to answer the user prompt, while the actual data populating the visualization is not subject to the uncertainties of AI/ML processing.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers to customize their chatbots. With the system performing discrete operations leveraging AI/ML models, separate from the core querying of an enterprise's proprietary datasets, the chatbots can be more easily integrated with the processing capabilities of third-party systems.

In one general aspect, a method performed by one or more computers includes: providing, by the one or more computers, an interface for creating or editing an interactive application configured to provide responses generated using one or more artificial intelligence (AI) or machine learning models; receiving, by the one or more computers, customization data through the interface, wherein the customization data indicates customizations specified by a user to customize the interactive application, wherein the customization data identifies a data set for the interactive application and specifies one or more characteristics of behavior of the interactive application; storing, by the one or more computers, one or more records specifying configuration settings representing the customizations for the interactive application; and providing, by the one or more computers, access to the interactive application with the customizations for one or more users, such that the interactive application is configured to generate a response to a user prompt using (i) a result determined from the data set based at least in part on the user prompt and (ii) content generated by the one or more AI or machine learning models from processing the result determined from the data set.

In some implementations, the interactive application comprises a chatbot, and the one or more AI or machine learning models comprises a large language model.

In some implementations, providing the interface comprises providing data for a user interface of a web page or web application.

In some implementations, providing the interface comprises providing an application programming interface.

In some implementations, providing the interface comprises providing user interface data for a user interface comprising (i) a set of interactive elements to that are selectable by a user to change settings of the interactive application, and (ii) a region for interacting with the interactive application, including an input control configured to submit user prompts and an output area configured to provide responses of the interactive application to the user prompts.

In some implementations, the interface includes one or more controls to alter an appearance of the interactive application; the customization data indicates customizations specified by the user that include changes to the appearance of the interactive application; and the stored one or more records indicate the changes to the appearance of the interactive application.

In some implementations, the interface includes one or more controls to alter one or more messages to provide to users of the interactive application; the customization data indicates customizations specified by the user that include the one or more messages; and the stored one or more records indicate the one or more messages to provide to users of the interactive application.

In some implementations, the interface includes one or more controls to set whether the interactive application can use information from the Internet to respond to user prompts; the customization data indicates customizations specified by the user that include a setting whether the interactive application can use information from the Internet to respond to user prompts; and the stored one or more records indicate the setting whether interactive application can use information from the Internet to respond to user prompts.

In some implementations, the interface includes one or more controls to control access to the interactive application by users; the customization data indicates customizations specified by the user that adjusts which users can access the interactive application; and the stored one or more records indicate criteria specifying which users can access the interactive application.

In some implementations, the interface includes one or more controls to limit an amount of usage of the interactive application by users; the customization data indicates customizations specified by the user that set a limit on the amount of usage of the interactive application by users; and the stored one or more records indicate the limit on the amount of usage of the interactive application by users.

In some implementations, the interface includes one or more controls to limit the portions of the data set that can be used to generate responses provided by the interactive application; the customization data indicates customizations specified by the user that specify a subset of the data set to be used by the interactive application to generate responses; and the stored one or more records indicate the subset of the data set to be used by the interactive application to generate responses.

In some implementations, the interactive application is configured to vary which portions of the data set are used to provide responses by the interactive application to different users based on respective permissions or access levels of the different users.

In some implementations, the one or more AI or machine learning models comprises a third-party AI or machine learning model; and the interactive application is configured to generate responses to user prompts based on (i) generating results to the user prompts from the data set using a data processing system, and (ii) providing the generated results to the third-party AI or machine learning model, so that the third-party AI or machine learning model generates content for the responses without direct access to the data set.

In some implementations, the result comprises result data generated by a database management system based on a query or set of processing operations determined using the user prompt; and the interactive application is configured to obtain the content from the one or more AI or machine learning models by requesting that the one or more AI or machine learning models summarize results from the database system.

In some implementations, the interactive application is configured to generate a response to a user prompt by performing operations including: sending a first request to the one or more AI or machine learning models based on the user prompt, wherein the first request requests instructions for analyzing the data set based on the user prompt; causing data processing instructions that the one or more AI or machine learning models generated in response to the first request to be carried out using deterministic processing of a data processing system separate from the AI or machine learning models; sending a second request to the one or more AI or machine learning models, including results generated by carrying out the data processing instructions and a request to generate text based on the results; and providing, in a response to the user prompt, text that the one or more AI or machine learning models generated in response to the second request.

In some implementations, the first request is a request for instructions specified in code of a programming language; and wherein causing the data processing instructions to be carried out comprises causing the instructions specified by the code of the programming language to be performed.

In some implementations, the interactive application is configured to respond to at least some user prompts with data for a visualization of data from the data set, wherein the interactive application is configured to request and receive data describing characteristics of the visualization from the one or more AI or machine learning models.

In some implementations, the visualization comprises a chart or graph of a type of data indicated by the one or more AI or machine learning models based on information from a user prompt, with the chart or graph depicting values for the type of data wherein the values are determined by a database system separate from the one or more AI or machine learning models.

In one general aspect, a method performed by one or more computers includes: receiving, by the one or more computers, a text input from a user that is entered at a user device of the user; identifying, by the one or more computers, multiple chatbots that the user is authorized to access, wherein at least some of the multiple chatbots are configured to answer questions about data from different data sources; selecting, by the one or more computers, a subset of the multiple chatbots based on the text input from the user, wherein the subset includes at least one of the multiple chatbots and fewer than all of the multiple chatbots; providing, by the one or more computers, the text input from the user to each of the chatbots in the subset to generate a response to the text input from each of the chatbots in the subset; and providing, by the one or more computers, an output response to the text input from the user for presentation at the user device, wherein the response is based on one or more of the responses generated the chatbots in the subset.

In some implementations, receiving the text input includes receiving the text input over a communication network at a server system; each of the multiple chatbots are configured to generate responses using one or more artificial intelligence and/or machine learning models; and providing the output response to the text input includes providing the output response from the server system over the communication network to the user device.

In some implementations, receiving the text input includes receiving the text input through an application programming interface (API).

In some implementations, the text input from the user is entered through a messaging interface or a chatbot interface, and wherein the messaging interface or a chatbot interface is configured to selectively provide access to each of the multiple chatbots without the user selecting or specifying which chatbot to interact with.

In some implementations, the one or more computers are configured to automatically select, for each of multiple user prompts, which of the multiple chatbots to use to respond to the user prompt.

In some implementations, the method includes receiving a series of user prompts in a conversation, and varying which of the multiple chatbots is used to answer the respective user prompts based on content of the respective user prompts.

In some implementations, the selected subset of the multiple chatbots includes at least two chatbots; and the output response is generated based on the responses of each of the at least two chatbots.

In some implementations, the output response combines information from the responses of the at least two chatbots.

In some implementations, the method includes generating the output response, including by using one of the responses of the at least two chatbots to verify or validate another of the responses of the at least two chatbots.

In some implementations, the method includes monitoring for subsequent interactions of the user after the output response is provided; detecting an interaction of the user after the output response is provided; and adjusting a process of selecting chatbots to respond to user input based on the detected interaction of the user.

In some implementations, the method includes storing a registry of chatbots, including storing an association of each of the chatbots with one or more topics, data sets, data objects, types of data, or keywords; and selecting the subset of the multiple chatbots includes selecting the subset of the multiple chatbots based on similarity or relevance of the topics, data sets, data objects, types of data, or keywords associated with the respective chatbots with respect to the text input from the user.

In some implementations, selecting the subset of the multiple chatbots includes using a machine learning model to select from among the multiple chatbots.

In another general aspect, a method performed by one or more computers includes: monitoring, by the one or more computers, messages in a messaging platform to detect a reference to an artificial intelligence or machine learning (AI/ML) chatbot system; based on the monitoring, detecting, by the one or more computers, a reference to the AI/ML chatbot system in a message in a conversation between two or more users; in response to detecting the reference in the message, selecting, by the one or more computers, a chatbot from among multiple chatbots to generate a response to the message that includes the reference, wherein the chatbot is selected based on content of the message; and providing, by the one or more computers, a response generated by the selected chatbot as a message in the conversation between the two or more users.

In some implementations, monitoring the messages includes monitoring for the presence of a predetermined keyword corresponding to the AI/ML chatbot system; and detecting the reference includes detecting the predetermined keyword in the message.

In some implementations, the method includes identifying a set of authorized chatbots that the users in the conversation are authorized to access; and the chatbot selected from among the identified set of authorized chatbots.

In some implementations, the conversation does not include a chatbot or agent of the AI/ML chatbot system as a participant in the conversation, such that the reference is provided before the AI/ML chatbot system participates in the conversation.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1A is a diagram showing an example of a system that uses an agent to manage interactions with multiple AI/ML models or applications, such as multiple AI/ML chatbots.

FIGS. 1B-1C are diagrams showing an example of creating, distributing, and using customized chatbots.

FIG. 2A is a diagram that shows additional information about an agent that can manage interactions with multiple AI/ML chatbots or other models or applications.

FIG. 2B is a diagram that shows information used to train the agent.

FIGS. 3A-3C are diagrams that show examples of the agent being used to manage interactions with AI/ML chatbots or other models or applications.

FIG. 4 is another example of the use of an agent to access different chatbots or data sets.

FIG. 5 shows another example of the system providing a unified interface for users to communicate with multiple chatbots.

FIGS. 6A-6B show additional user interfaces that can be used to access chatbots.

Like reference numbers and designations in the various drawings indicate like elements.

### DETAILED DESCRIPTION

In some implementations, a system can use an agent to facilitate access to chatbots and other AI/ML functionality. The agent can provide a consistent, unified interface to the user across many different chatbots from different sources. A chatbot can be a single interface, connected to one or more datasets, that is able to answer questions about its corresponding data sets. A chatbot can combine reliable database operations (e.g., deterministic or non-stochastic processing) and information retrieval with generative AI/ML processing, using retrieval-augmented generation (RAG) or other techniques. The agent can provide a single interface to a user as a way to combine or the chatbot experiences or interfaces that a user has access to in an enterprise environment.

In operation, the agent can largely abstract the details of many chatbots that a user may have access to, so the user does not have to select and seek out the specific chatbot interface for each chatbot one-by-one and question-by-question. The agent can automatically select which of multiple chatbots should answer a user's question, so the user does not need to manually select or specify which chatbots to interact with. As a result, the agent interface provides a single, unified interface across many different chatbots. This allows quick access to the chatbots and allows the user to carry on a conversation that changes in topic or domain from question to question, even if that would involve switching from one chatbot to another.

As an example, a user at a company may have access to three chatbots that have access to different datasets, such as a chatbot for product technical specifications, a chatbot for product sales information, and a chatbot for human resources at the company. The user can ask a first question about a product's specifications to the agent, and based on the content of the question the agent can route that question to the technical specifications chatbot and give the user the answer from the technical specifications chatbot. As the next question in the session, the user can ask the chatbot about sales of the product discussed in the previous question. Based on the content of the second question, the agent can route the second question to the product sales chatbot instead. In doing so, the agent can include the first question and answer as context, allowing the product sales chatbot to better interpret the second question (e.g., to correctly disambiguate references to items mentioned in the first question and answer). The agent then gives the user the answer to the second question that the product sales chatbot provided, in the same consistent user interface that also showed the first question's answer from the technical specifications chatbot.

Because the agent can manage the querying of chatbots on behalf of the user, based on the relevance of the respective chatbots for the current user prompt and context, the user does not need to know which chatbots are available or are most appropriate for the current question. This frees the user to focus on forming appropriate questions, without the need for the user to evaluate which chatbots are available to the user and which datasets or capabilities the various chatbots possess. In some implementations, the agent selects chatbots, distributes user prompts, and returns responses in a manner that abstracts away the underlying complexity. For example, the interface may not even indicate to the user the number of chatbots that are available, or which chatbots are being queried, or which chatbots provided specific answers, unless the user requests the information or requests to chat with specific chatbots.

The agent can include various capabilities to reliably select chatbots that provide accurate and relevant results to user questions, from among a larger set of chatbots. As discussed further below, the agent can track user interactions and derive explicit and implicit user feedback about which chatbot responses are acceptable to users and which are not. From the examples, the agent can learn which chatbots are most suited for specific domains, topics, keywords, datasets, tasks, user roles, users, user groups, and so on. The agent can continue to learn from user interactions in an ongoing manner, such as by updating an AI/ML model (e.g., neural network, classifier, decision tree, etc.) to increase accuracy in selection of chatbots over time.

The agent can also perform operations to validate or verify responses from chatbots, which can help mitigate or overcome an initial selection of chatbots that is not ideal. For example, the agent can examine responses received from chatbots and identify patterns or phrases that indicate the chatbot's answer is not useful (e.g., phrases such as “I'm sorry . . . ,” “I cannot answer that . . . ,” “ . . . database does not include . . . ,” and so on). The agent can filter these types of error responses so that they are not provided to the user, and the agent can also use instances of errors or non-responsive text for training to avoid asking those chatbots those types of questions. In addition, the agent can compare answers among chatbots to detect conflicting or inconsistent answers. The agent can also compare terms or semantic concepts in the user's question with terms and concepts in the answers of various chatbots to determine if the answers are sufficiently related in topic, meaning, or similarity to meet a relevance threshold. If an initial set of chatbot responses produces only errors, or does not produce a response with sufficiently high quality, the agent can reissue the question to a different set of chatbots. In this manner, the agent can alter or expand the set of chatbots that is asked to respond to a user prompt, potentially in an iterative or progressive manner, until a sufficiently relevant or high-quality response is received or all of the chatbots have been consulted.

The agent can then provide a response to the user based on the best, e.g., most relevant, responses received from the chatbots. For example, depending on the circumstances and the settings of the agent, the agent can provide the response to a user prompt as (1) the chatbot response that the agent rates as having the highest relevance, (2) a combination of the chatbot responses that each meet a relevance threshold, (3) a summary of chatbot responses that meet a relevance threshold, (4) the top n chatbot responses, where n is a predetermined integer (e.g., 2, 3, 5, etc.), or another type of response

Although many of the examples below refer to an agent that manages interactions with chatbots, the same techniques can similarly be used to select other AI/ML tools or functionality. For example, an agent may learn to select which of multiple large language models (LLMs) a particular chatbot uses to answer a question, so that the agent varies which LLM is used depending on the user prompt provided to the chatbot. As another example, an agent may be used to provide multi-modal outputs from different AI/ML models or services, such as by selecting among chatbots (e.g., generating primarily text content), image generation services (e.g., generating primarily image content), video generation services (e.g., generating primarily video content), function calling models (e.g., generating primarily application programming interface (API) requests and invoking local or remote functions or procedures), and so on. In general, the agent and its learning capabilities can be applied to automatically learn and select from among any of various AI/ML capabilities to reduce or avoid the need for a user or system to make the selection.

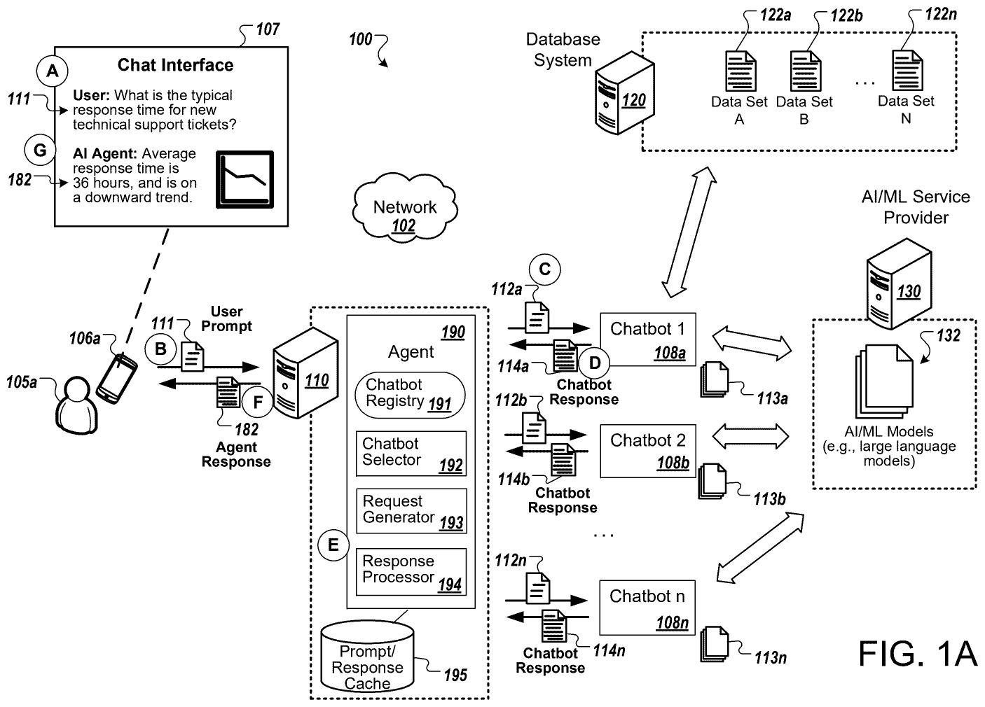

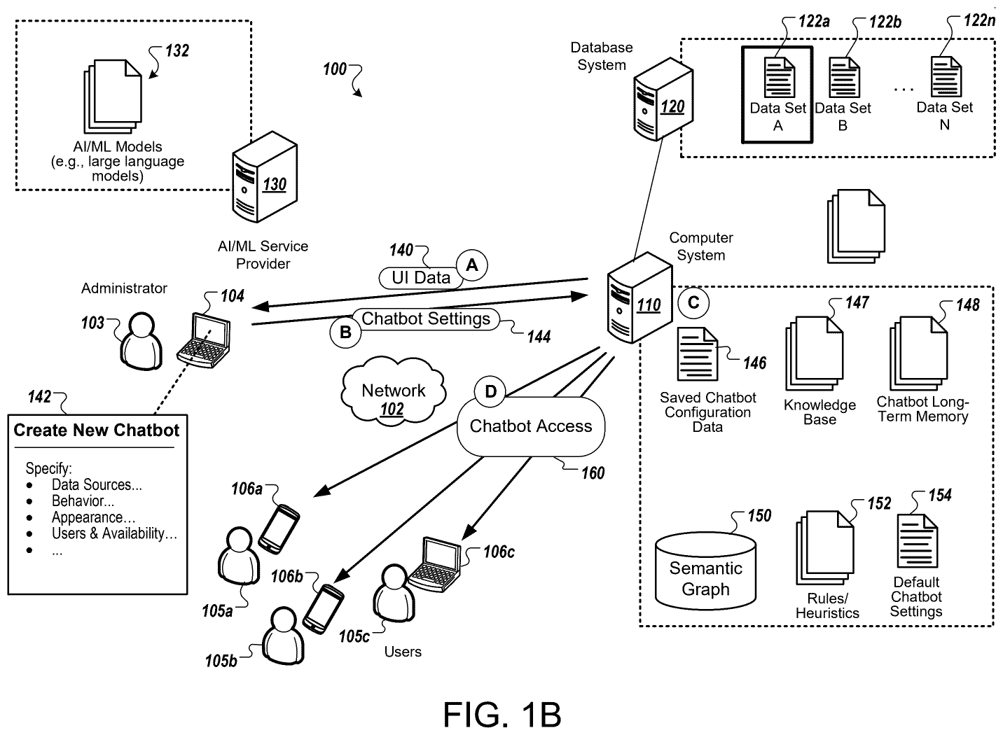

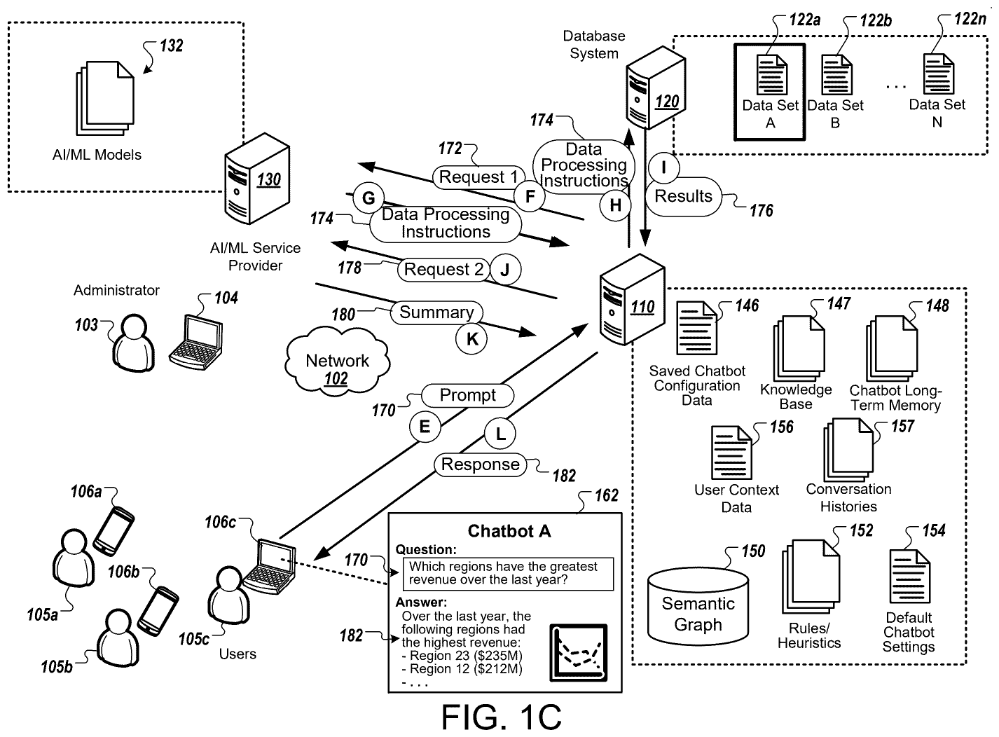

FIG. 1A is a diagram showing an example of a system that uses an agent 190 to manage interactions with multiple AI/ML models or applications, such as multiple AI/ML chatbots 108a-108n. The system 100 includes a computer system 110, a database system 120, and a AI/ML service provider 130. The elements of the system 100 communicate over a network 102, such as the Internet. The computer system 110 coordinates a variety of operations to provide and manage access to chatbots 108a-108n and other AI/ML applications. The computer system 110 also coordinates creating and operating chatbots 108a-108n and other AI/ML applications. The example of FIG. 1A includes stages (A) to (G), which represent various operations and a flow of data, and which can occur in the order illustrated or in a different order.

The computer system 110 includes the agent 190, which can be implemented as server-side software that runs at the computer system 110. In some implementations, some or all of the functionality of the agent 190 may reside on a user device 106a of a user 105a, in addition to or instead of residing at the computer system 110.

The agent 190 receives user prompts from users, distributes each user prompt to one or more of the chatbots 108a-108n selected by the agent 190, and provides a response to each user prompt based on the chatbot responses the agent 190 receives. For example, when the user 105a submits a user prompt 111 (e.g., a question or query) using the user device 106a, the user prompt 111 is provided to the agent 190, which may decide to send the user prompt 111, potentially along with additional context information, in a set of requests 112a-112n to multiple chatbots 108a-108n. Each of the chatbots 108a-108n that receive a request 112a-112n generates and sends a response 114a-114n to the agent 190. The agent 190 evaluates the chatbot responses, for example, to filter out low-quality or irrelevant chatbot responses and select the most applicable chatbot responses. The agent 190 then provides an agent response 182 that includes content derived from the processed chatbot responses. For example, the agent response 182 can be the most relevant or highest-scoring chatbot response selected by the agent 190 or a combination or aggregation of multiple chatbot responses.

The computer system 110 can be implemented using one or more servers, such as one or more cloud computing systems, one or more on-premises servers, etc. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface. As discussed further below, the computer system 110 performs various other functions to generate and save customized chatbots, to manage and grant access to existing chatbots, and to coordinate the processing of user prompts to generate responses from the chatbots.

The database system 120 can provide various data retrieval and processing functions. For example, the database system 120 can be a database management system (DBMS), and can include the capability to process operations specified in structured query language (SQL), Python code, or in other forms. The database system 120 has access to various datasets 122a-122n, which can be private datasets for organization, such as a company. The database system 120 can store and use datasets in any of various forms such as tables, data cubes, or other forms.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

The chatbots 108a-108n can be provided by the computer system 110 or other systems, including third-party systems. Some or all of the chatbots 108a-108n may be executed or managed by the same server system or same operator as the agent 190, but this is not required. In fact, one of the advantages of the agent 190 is that it can combine access to a variety of different chatbots, offered or executed by a diverse set of systems or parties, in a single interface. The agent 190 also has the functionality to learn the capabilities and best uses of different chatbots 108a-108n over time through the responses the chatbots 108a-108n give, so the agent 190 does not need extensive knowledge about each chatbot 108a-108n initially. The agent 190 can include or can access a chatbot registry 191 that identifies available chatbots 108a-108n and indicates the APIs or interfaces used to make requests and receive responses from each chatbot 108a-108n. The chatbot registry 191 can include information about chatbots 108a-108n, such as the respective topics, keywords, subject matter domains, datasets, types of data, etc. for the chatbots 180a-180n, but this is not initially required and in many cases sufficient information can be gathered over time by examining chatbot responses.

In the example of FIG. 1A, the agent 190 sits above the chatbots 108a-108n in the hierarchy, and the user 105a does not interact directly with an individual chatbot 108a-108n. Instead, user queries and chatbot responses pass through the agent 190. Each chatbot 108a-108n can have an associated dataset 122a-122n (or multiple datasets) from which the chatbot 108a-108n derives responses to user. Each chatbot 108a-108n can also have a corresponding AI/ML model 132 designated to use for generating responses from the chatbot, such as a LLM. Each chatbot 108a-108n can also have a corresponding set of settings and customizations that specify various properties of the chatbot (e.g., text output tone and style, output format, verbosity, etc.). Different chatbots 108a-108n may use different datasets 122a-122n or share the same datasets 122a-122n, and similarly different chatbots 108a-108n may use different AI/ML models 132 or share the same AI/ML model 132.

Each chatbot 108a-108n can also include functionality to store conversation histories for each user across different sessions of use. In other words, for the user 105a, each chatbot 108a-108n can store a separate, persistent chat history for the interactions of the user 105a. In some implementations, this chatbot conversation history is used by the chatbots when user prompts (e.g., questions) are routed to the chatbots 108a-108n by the agent 190. In other implementations, the conversation history is used by the chatbots 108a-108n for prompts that the user addresses directly to specific chatbots, and the chat histories are updated based on those prompts, but not for prompts that the agent 190 routes to the chatbots 108a-108n, in order to preserve the context of context of the user's chat with a chatbot separate from requests routed by the agent 190. In other implementations, the chat histories are used to answer and is updated based on prompts directly addressed to the chatbots 108a-108n by the user and when the agent 190 selects the chatbots 108a-108n for a given prompt (e.g., due to the topic or data set 122a-122n that is relevant), but not for during the learning phase when the agent 190 is purposefully overinclusive and may send prompts that are not highly relevant to the subject matter or domain of a particular chatbot 108a-108n.

Different users have access to different datasets 122a-122n and chatbots 108a-108n, depending on their roles, permissions, etc. The user 105a authenticates to the computer system 110, so that the user's identity is determined and the user's permissions can be determined. Based on the user's identity, permissions, and access control data (e.g., access control lists specifying authorized users), the agent 190 determines which of the chatbots 108a-108n (and/or their corresponding datasets 122a-122n) the user 105a has access to, and selects chatbots 108a-108n from among the set the user 105a is authorized to access. When a chatbot 108a-108n provides a response, the chatbot 108a-108n can provide a chatbot identifier for itself, which demonstrates the source of the response data, e.g., which chatbot 108a-108n and/or dataset 122a-122n was used to obtain that response.

The agent 190 can be configured to automatically adjust to a varying set of chatbots 108a-108n that may be available. For example, in an enterprise setting, administrators may add new chatbots or remove existing chatbots from time to time. These changes can be saved to the chatbot registry 191 or can be otherwise indicated to the agent 190 so the agent 190 can update the chatbot registry 191. As the set of chatbots 108a-108n changes, the agent 190 continues to learn which chatbots 108a-108n are most appropriate for different types of user requests. For example, when a new chatbot is added, the agent 190 can begin to send user requests to the newly added chatbot, to gain response examples that the agent 190 can use to train its chatbot selection model or other selection components (e.g., weighting values indicating relevance of chatbots to factors such as topics or keywords, mapping tables indicating associations between chatbots and factors such as topics and keywords, etc.).

The learning performed by the agent 190 can begin with an initial phase where the agent 190 distributes user prompts to a large set of chatbots 190. The agent 190 can purposefully route user prompts to an over-inclusive set of chatbots 108n-108n to explore the capabilities of the chatbots 108n-108n and to quickly gather response examples for a wide variety of prompts, so the response examples can be used as training data. For example, when the agent 190 is first deployed for an organization, the agent 190 can distribute each user prompt to all of the available chatbots 108a-108n that the user is authorized to access. In some implementations, different organizations (e.g., different companies, different departments, etc.) may use very different sets of chatbots, and may actually use large numbers of customized or private chatbots. As a result, the agent 190 learns separately for each organization, based on the observed behavior of an organization's particular set of chatbots 108a-108n and the behavior (e.g., user prompt topics and patterns) of the organization's particular users. Thus, the agent 190 can perform the operations for training data collection and chatbot selection learning separately for each organization with which the agent 190 is deployed.

As an example, if the user 105a is registered with or has permissions on an access control list to interact with 10 different chatbots 108a-108n, when the user 105a sends a query to the agent 109, the agent 190 sends the query to each of the 10 different chatbots 108a-108n. Many of those chatbots 108a-108n may not be relevant for the question in the user prompt, because they are not associated with datasets 122a-122n that contain the answer the user's question. For example, 8 out of the 10 chatbots may respond with an answer “I'm sorry, I don't know the answer to that question” or “I don't have the information to answer this question.” For those responses, the agent does not pass the responses along to the user, so the user is not burdened by replies that do not give the user what is wanted. These error phrases or low-quality responses still provide the agent 190 valuable information about the topics, keywords, and subject matter domains that those chatbots 108a-108n are not able to assist with, so the agent 190 can learn not to ask those chatbots 108a-108n for those items in the future. Out of the 10 chatbots asked, two may have the appropriate dataset 122a-122n that includes the data needed to answer the user's question, and each of the two chatbots would provide the agent 190 its answer to the user's question. The agent 190 provides the two relevant responses to the user 105a. For example, the agent 190 can show the user 105a all responses that agent 190 does not classify as an error or inability to answer. As another example, the agent 190 may score the chatbot responses and select to show chatbot responses that satisfy a set of criteria (e.g., meeting thresholds for relevance, quality, etc.). If the responses from multiple chatbots 108a-108n align (e.g., match, are consistent, or have similarity above a threshold), the agent 190 and the user 105a can have high confidence that the chatbot answers are correct. If the responses from the two chatbots conflict or differ significantly, the user 105a can follow up with additional questions to clarify and identify the reason for the difference.

In the example of FIG. 1A, in stage (A), the user 105a accesses a chat user interface 107 for interacting with AI/ML chatbots using a user device 106a (e.g., a phone, a laptop computer, a desktop computer, etc.). For example, the chat interface 107 can be part of a web page, a web application, a native application on the user device 106a. The chat interface 107 can be displayed based on user interface data provided by the computer system 110 or another server. The user 105a interacts with the chat interface 107 to enter a user prompt 111, which in this example is the question, “What is the typical response time for new technical support tickets?” The user 105a has previously been authorized to access multiple chatbots, in this case, all of the chatbots 108a-108n. Before submitting the user prompt 111, the user 105a has logged in and authenticated, so the computer system 110 is aware of the identity of the user 105a and can grant and limit access based on the user's permissions.

The chat interface 107 is configured so the user 105a can ask questions to be answered by AI/ML chatbots, without the user 105a selecting or specifying which chatbot(s) 108a-108n should answer the question. For example, in the view of the chat interface 107 shown, the user 105a is not shown a list of available chatbots 108a-108n and is not required to select or name specific chatbots 108a-108n to receive or respond to the user prompt 111. In some implementations, the chat interface 107 can provide the user 105a the option to direct a user prompt 111 to a specific, user-selected chatbot 108a-108n or set of chatbots 108a-108n. Even if that functionality is not provided or is no used by the user, the system 100 allows the user 105a to gain access to all of the chatbots 108a-108n through the operations of the agent 190.

In stage (B), the client device 106a of the user 105a sends the user prompt 111 to the computer system 110 over the network 102, and the user prompt 111 is received and processed by the agent 190. As discussed above, in this example the agent 190 is implemented as a software module or service that executes at the computer system 110. There is a single agent 190, which serves an intermediary between users and chatbots 108a-108n, to manage the transmission of user prompts to the chatbots 108a-108n and to select and compile the best responses from the chatbots 108a-108n to provide to the user 105a. Because the agent 190 provides a single, consistent interface for users to all of their available chatbots, the interface with the agent 190 is more efficient for users and does not require users to have knowledge about the set of chatbots available. As a result, the agent 190 provides what is effectively a chat interface to all of the user's chatbots, a single interface that will selectively show answers from different chatbots 108a-108n depending on which answers the agent 190 determines to be most relevant and useful.

In stage (C), the agent 190 sends the user prompt 111 to a selected group of chatbots 108a-108n. In the example, the agent 190 generates and sends a request 112a-112n to each of the chatbots 108a-108n, where each request 112a-112n can include the user prompt 111 and potentially additional information, such as the context of previous user prompts and responses in the conversation, a knowledge base or dictionary of important terms, and so on.

The agent 190 uses the chatbot registry 191 and/or access control lists to identify the set of chatbots 108a-108n that the user 105a is authorized to access. The agent 190 then uses a chatbot selector 192 module to select, from among the identified set of chatbots 108a-108n authorized for the user 105a, a set of chatbots 108a-108n to receive the user prompt 111. The agent 190 then uses a request generator 193 module to generate the requests 112a-112n that provide the user prompt 111 and additional context information to the respective chatbots 108a-108n in the selected set. As a result, after the user 105a has sent the user prompt 111 to the agent 190, the agent 190 propagates or forwards the user prompt 111 in the requests 112a-112n to some or all of the chatbots 108a-108n. The agent 190 here performs a routing function by providing the user prompt 111 from the user 105a to the chatbots 108a-108n.

When the agent 190 is newly deployed for an organization, the agent 190 operates in a learning phase where, for each prompt, the agent 190 sends the prompt to many or even all the chatbots 108a-108n that the user 105a has access to. This allows a comprehensive set of chatbot answers to be generated, to explore the quality of answers that the various chatbots 108a-108n provide on a wide range of topics. This results in high computational load, because the execution or inference processing for each user prompt 111 is multiplied by the number of chatbots 108a-108n available for that user, and many of the available chatbots 108a-108n may not have the data to correctly answer the question. The high resource use is helpful in the learning phase, however, because it quickly generates a large amount of information about the capabilities and data available from the various chatbots 108a-108n. In some cases, passing through the results of various chatbots 108a-108n can also prompt a large set of feedback information from users about the quality of the responses given by chatbots.

Over time, as the agent 190 observes prompts from users and corresponding responses from chatbots 108a-108n, the agent 190 learns the types of prompts that are most appropriate for different chatbots 108a-108n. For example, the agent 190 learns which chatbots 108a-108n have access to different types of data (e.g., which may or may not be already specified in the chatbot registry 191), and learns the conditions or prompt types for which different chatbots 108a-108n provide failure messages or provide low-quality responses. Similarly, the agent 190 can learn from user feedback, whether from explicit ratings (e.g., thumbs up or thumbs down, numerical rating, etc.) or implicit feedback (e.g., accepting an answer and asking a follow up question vs. editing and retrying the question), which chatbots 108a-108n typically perform the best for different topics or keywords (and thus should be selected to answer prompts containing those topics or keywords) and which chatbots 108a-108n typically perform the worst for different topics and keywords (and thus should not be selected to answer prompts containing those topics and keywords). In general, the system captures many types of platform analytics, including the prompt submitted, session context or history for the prompt, user interactions with the chatbot response after the chatbot response is provided or other user actions in the conversation, and user ratings of the value or correctness of the chatbot for that question.

The agent 190 can include or use a machine learning model that learns the overall or average preferences across an organization (e.g., across a group of multiple users sharing the same data sets and chatbots). The machine learning model can additionally or alternatively learn the preferences of individual users. For example, for a given query, one particular chatbot 108a may have a 75% positive rating overall for that type of query. The positive feedback rating for a specific user, however, may be different, such as by being predominately negative from the user for that combination of query type with the particular chatbot 108a, more so than for the aggregate data as a whole. The agent 190 can use the history of behaviors of the user 105a, or the history of interactions of that user 105a and ratings from the user, to better select chatbots 108a-108a for that user 105a.

The learning phase of operating the agent 190 can continue until a predetermined condition is reached, such as an amount of time has passed, a minimum number of prompts are processed, a minimum number of example response are received from chatbots, or until the predictive portion of the agent 190 (e.g., the machine learning model or algorithm) reaches a threshold level of accuracy is reached. Then, the agent 190 can be used in to route prompts 111 more selectively to the chatbots 108a-108n. In other words, after the agent 190 has sufficient learned about the capabilities of the various chatbots 108a-108n and the preferences of the users, the agent 190 can scale back the number of chatbots 108a-108n that are asked to respond to each prompt. For example, if the agent 190 in the learning phase sent each prompt to ten chatbots 108a-108n, once the learning phase is over the agent 190 may send each subsequent prompt to a smaller number of chatbots 108a-108n, such as five, or three, or two chatbots 108a-108n that the agent 190 predicts are most likely to provide the answer needed. For example, the agent 190 may be configured to send the prompt to a fixed number of chatbots 108a-108n, such as the top two or top three chatbots 108a-108n predicted to be the best match for the prompt and its context. As another example, the number of chatbots 108a-108n queried per prompt may vary, such as with the agent 190 being configured to send each prompt to each chatbot 108a-108a predicted to have at least a minimum threshold likelihood score. In both examples, the agent 190 selectively sends prompts to a proper subset (e.g., fewer than all) of the available chatbots 108a-108n for the user 105a, according to the predictions or scoring of the agent 190 (e.g., to the N top-scoring chatbots 108a-108n, where N is an integer, or to each of the chatbots 108a-108n having a score that satisfies a threshold for likelihood or relevance). Through the learning process and subsequent selective routing of queries, the agent 190 provide accuracy in the selection of relevant chatbots 108a-108n through its informed predictions, while significantly reducing the computational resources expended for each prompt.

In general, a single agent 190 is used for multiple users within a organization. For example, each organization can have an instance of the agent 190 that learns overall or aggregate preferences across the organization, even as users have access to different sets of chatbots. Even so, the agent 190 can use information about subsets of users or even individual users to tailor predictions for them, such as by giving weight to specific user feedback of a user in the predictions or to use user identity or user group membership as a feature assessed by the machine learning model during training. Different organizations can have different instances of the agent 190, which observe different patterns of use and feedback as well as learn to operate with different sets of chatbots, which can be customized or specific to an organization.

In stage (D), the chatbots 108a-108n that receive a request 112a-112n to respond to the prompt each generate and provide their responses 114a-114n to the agent 190. The chatbots 108a-108n can each separately and independently act on their respective requests 112a-112n in parallel. Each chatbot 108a-108n that is queried can provide a response 114a-114n to the same prompt 111. In the example, the computer system 110 hosts or executes the various chatbots 108a-108n and so coordinates the response generation, but this is not required. The chatbots 108a-108n, the data sources they use, and the AI/ML models (LLM) used may be operated or managed by different parties, including third-party providers. An example of processing performed to generate a chatbot response is discussed in more detail with respect to FIG. 1C.

In stage (E), the agent 190 analyzes the chatbot responses 114a-114n and generates an overall response 182 to provide to the user 105a. The agent 190 can perform a variety of functions to analyze the responses 114a-114n, including filtering errors and failure responses to hide those from the user 105a. For example, responses that meet certain criteria can be filtered when they match a predetermined pattern or phrase, such as “I'm sorry . . . ” “ . . . not in my database . . . ” “cannot answer,” and so on. The agent 190 can also compare the responses 114a-114n with the content of the prompt 111 to verify relevance, compare responses 114a-114n to each other to evaluate consistency, and perform other checks to score the responses 114a-114n for quality, relevance, accuracy, or other characteristics.

The agent 190 can generate the response 182 to be presented to the user 105a by selecting and providing the response 114a-114n that the agent 190 determines to be the most relevant or highest quality. In many cases, the agent 190 can provide content of multiple responses 114a-114n, such as by providing the top two best responses 114a-114n or all responses 114a-114n that satisfy a minimum threshold score. In some cases, the agent 190 can provide content that combines multiple responses 114a-114n, so that the response 182 merges or blends content from multiple chatbots 108a-108n.

In stage (F), the computer system 110 sends the response 182 to the user device 106a over the network 108 as the response from the agent 190. In stage (G), the user device 106a displays the response 182 in the chat interface 107. The user 105a thus can see the best answer content from among the responses 114a-114n of multiple chatbots, without the user 105a needing to identify or select chatbot(s) for the user prompt 111 in advance. The selection of chatbots, routing of the user prompt 111 to them, analysis of the responses 114a-114n, and generation of the response 182 is hidden from the user 105a.

The agent 190 solves some of the scaling problems that will result from the creation of many chatbots will face. Currently when there are multiple chatbots, The user has to consider which chatbot is likely best for the given prompt or context and manually select it. Or, in other cases, the chatbot used may be predetermined or limited by the current dataset or interface being used, and so may limit the set of questions the user can obtain answers to. By contrast, using the agent 190 is very scalable to allow access to a large number of different chatbots, and there is a single consistent front-end interface for the user for accessing any of the chatbots. The user is relieved of the need to choose which chatbot to ask a question. In addition, with the agent 190 allowing a unified front-end interface to many chatbots, the user's interface and cognitive load is not affected as the set of available chatbots varies over time, such as when new chatbots are made available, or older chatbots are removed from availability, etc.

In some implementations, the agent 190 provides additional features to improve responsiveness and efficiency. For example, the agent 190 can include or access a cache 195 (e.g., temporary storage) that stores recent prompts and corresponding responses of the agent 190 after obtaining responses from the chatbots 108a-108n. When the agent 190 receives a new prompt, the agent 190 can compare the prompt to those in the cache 195. If the received prompt matches or has at least a threshold similarity to one stored in the cache 195, the agent 190 can provide the cached response for the identified prompt instead of asking the chatbots 108a-108n. This allows common or high-frequency prompts to be answered with very low latency and also to avoid incurring the computational resources of generating new chatbot responses for these prompts.

FIGS. 1B-1C are diagrams showing an example of the system 100 creating, distributing, and using interactive applications such as customized chatbots. The system 100 includes a computer system 110, a database system 120, and a AI/ML service provider 130. The elements of the system 100 communicate over a network 102, such as the Internet. The computer system 110 coordinates a variety of functions for creating and operating chatbots. For example, the computer system 110 interacts with a client device 104 of an administrator 103 to receive customization data that indicates customizations for a chatbot. The computer system 110 then provides access to the customized chatbot to client devices 106a-106c of other users 105a-105c, and the computer system 110 coordinates processing to generate and provide answers to questions and other user prompts provided to the customized chatbot.

The example of FIGS. 1B-1C includes stages (A) to (L), which represent various operations and a flow of data, and which can occur in the order illustrated or in a different order. In FIG. 1B, stages (A) to (D) show an example of creation of a customized chatbot and access being provided to users. In FIG. 1C, stages (E) to (L) show an example of the customized chatbot being used, from issuance of a question or prompt 170 from a user to display of a response 182 from the customized chatbot.

As an overview, to create a customized chatbot, the administrator 103 interacts with the computer system 110 to specify the features and behavior that are desired for the chatbot. Through a series interactions, the administrator 103 can specify characteristics such as which dataset(s) 122a-122n the chatbot will use to generate responses, the appearance and style of the chatbot interface, whether the chatbot can access data from the Internet or other sources, access control settings, and so on. The computer system 110 saves the settings specified by the administrator 103 and creates a new chatbot

To provide the interface, the computer system 110 can provide data for a web application, web page, or native application that, when rendered on a client device, provides the functionality to specify settings of the chatbot.

In stage (A), the computer system 110 provides user interface data 140 to the client device 104 over the network 102. For example, the computer system 110 can provide content of a web page or web application for creating or editing the customized chatbot. The user interface data 140 is rendered on the display of the client device 104, represented by user interface 142.

The user interface 142 provides controls to specify many different properties of the chatbot. For example, the user interface 142 enables the administrator 103 to specify the data source or dataset that the chatbot will draw from to provide responses. The user interface 142 also allows the administrator 103 to specify various aspects of the behavior of the chatbot, including suggestions, instructions to the user, and more. The user interface 142 also includes controls for the administrator 103 to specify characteristics of the appearance of the chatbot, including color schemes, layout, formatting, size, and other characteristics. The user interface 142 also includes controls for the administrator 103 to specify access control, such as to specify which users can access the chatbot, the number or frequency of questions users are permitted issue to the chatbot, the platforms or interfaces in which the chatbot is available, and so on.

In stage (B), the administrator 103 uses the interface 142 to enter the settings that customize the appearance and operation of the chatbot. The client device 104 sends the specified settings 144 to the computer system 110 over the network 102.

As an example, the administrator 103 selects a particular dataset 122a as the data source for the chatbot, as a result, the chatbot will generate responses based on the information in this dataset 122a. In some implementations, each chatbot is focused on a specific dataset or collection of records. This can allow the chatbot to be tailored closely to a specific application, task, purpose, or set of users or roles in an organization. In addition, limiting the scope of data that the chatbot can access can improve accuracy in responses by limiting the amount of extraneous information that might otherwise be introduced. In addition, focusing a chatbot on a specific dataset can increase performance and reduce response times, by reducing the complexity and amount of data that needs to be processed to generate answers.

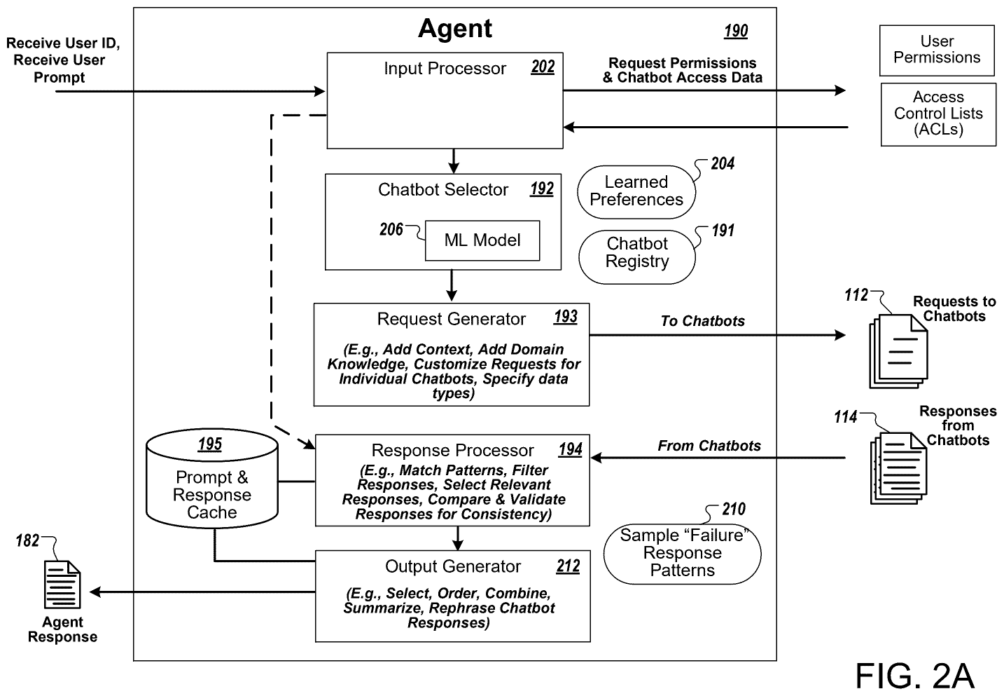

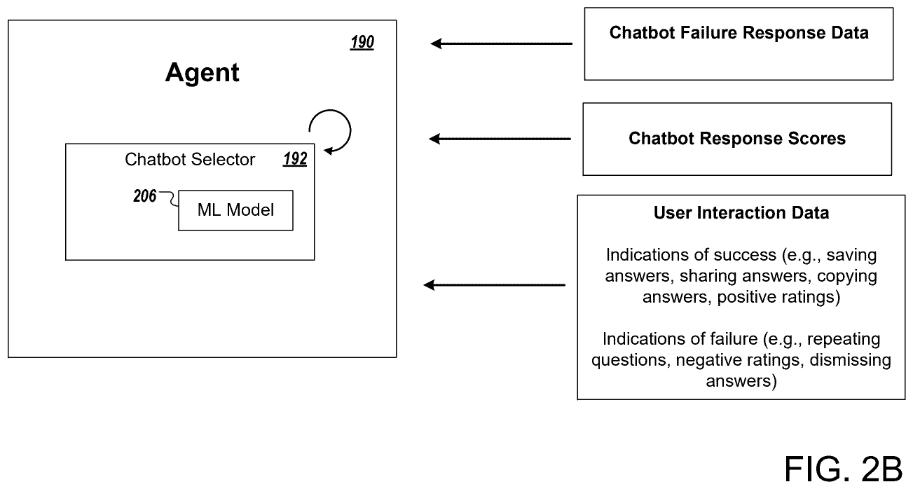

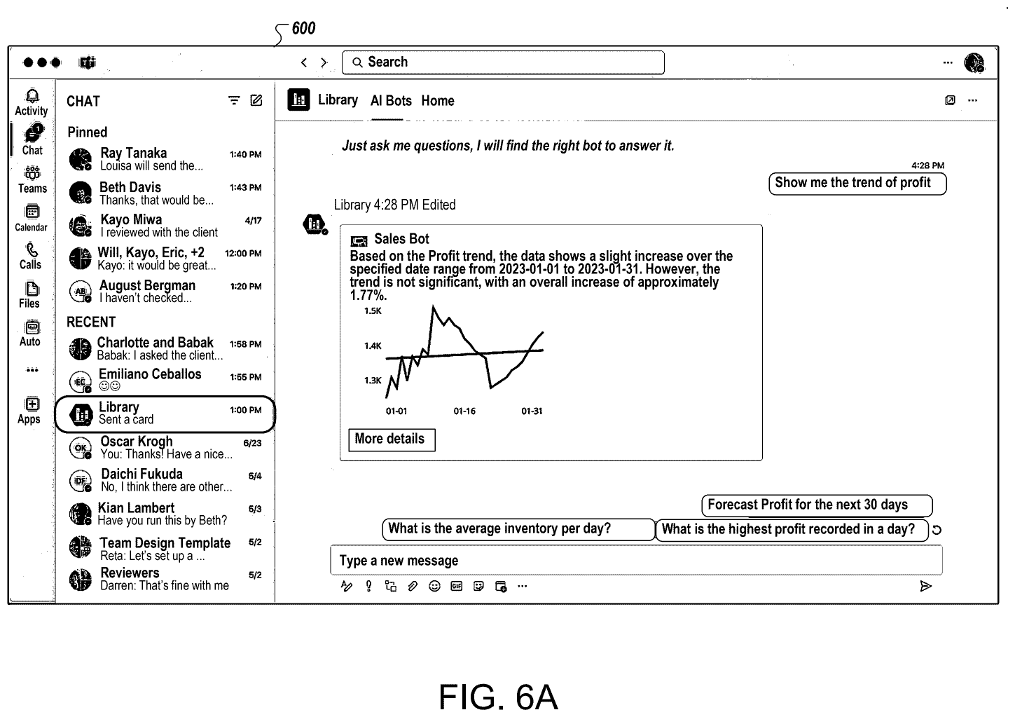

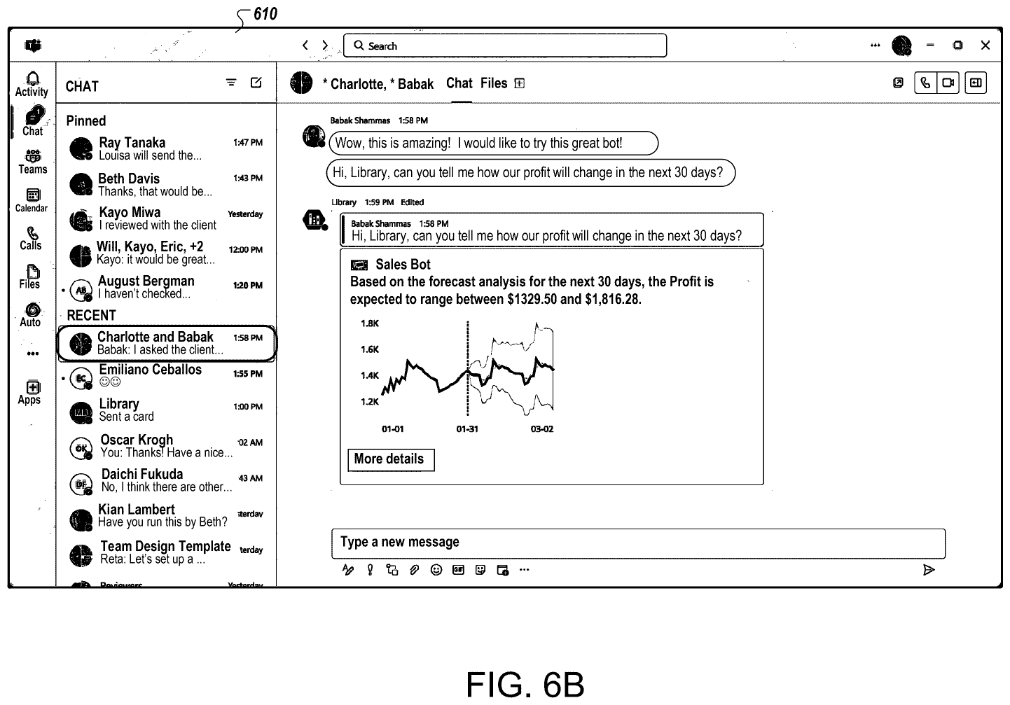

The process of specifying the settings for the chatbot can be iterative, with potentially multiple rounds of the administrator 103 interacting with the user interface 142 to incrementally adjust and test the settings of the chatbot. For example, as discussed below for FIG. 6A, the user interface 142 can provide a preview area or test panel in which the chatbot can run and provide interactions with the administrator 103 during the process of specifying the customized chatbot settings 144. As the administrator 103 makes changes to the chatbot settings, the administrator 103 can issue questions to the chatbot and evaluate the responses and interaction behavior with the newly updated settings, allowing the administrator 103 to make further changes based on the results experienced. FIGS. 2-6E, discussed further below, show examples of the user interface 142 and further illustrate the types of settings that can be adjusted to customize the chatbot.

Referring still to FIG. 1B, in stage (C), the computer system 110 uses the customized chatbot settings 144 from the administrator 103 to generate and save the data and settings that define the chatbot. In the example, this is shown as saved chatbot configuration data 146. For example, the computer system 110 can create a record or series of records representing the new chatbot and its customized settings. For each chatbot, the computer system 110 saves a separate set of records or definitions that specify the characteristics and customizations of that chatbot. For example, each chatbot can have a set of saved chatbot configuration data 146 that specifies, among other items, the name of the chatbot, the dataset for the chatbot, a selection of which AI/ML models 132 to use for the chatbot, the appearance and formatting characteristics of the chatbot, access control information for the chatbot, customized instructions to append to or include in user prompts to AI/ML models, and so on.

The computer system 110 can include a number of modules and datasets that facilitate the generation of new chatbots. For example, the computer system 110 can include a set of default chatbot settings 154 that provides a default or base configuration for new chatbots. The customizations specified in the received chatbot settings 144 can override or replace settings in the default set of chatbot settings 154 to form the final set of saved chatbot configuration data 146.

Generating and saving the chatbot can include registering the chatbot with a number of different applications, web pages, web applications, or other services. For example, the computer system 110 can register the new chatbot, with its name, capabilities, and applicable context, so that the option for the chatbot appears for users who have been granted access. For example, the chatbot can be made available through the document libraries of users who are approved to access the chatbot.

In some implementations, the computer system 110 enables the administrator 103 to attach one or more additional data sets to adjust the operation and output of the chatbot. For example, an additional data set can be a knowledge base 147 or data dictionary can be added. Unlike the primary data set that the user selects for the chatbot (e.g., data set 122a), the chatbot is not configured to answer questions about the additional data set or to retrieve metrics or to provide visualizations of the knowledge base 147. Instead, the knowledge base 147 can be provided to assist the chatbot in interpreting user queries and providing responses with the terminology for the user's organization. In general, the knowledge base 147 can function to provide contextual knowledge to the AI/ML models 132, so the models can classify and use the nomenclature of the end user when generating answers to user prompts.

Many different organizations or departments use terms that have a special contextual meaning, or are not part of general language, and so would not be available for training of an LLM. For example, a company may internally use various names for its products, projects, teams, locations, policies, initiatives, organizational structure, and so on. For example, a company be developing a product with a codename of “starfish” that being developed by a group of employees called “red team.” The training state of an LLM would not incorporate information about these entities, which are specific to the company and not referenced in public documents. To enable the chatbot to process questions about these internal entities and provide answers that reference them, a knowledge base 147 is designated for the chatbot to describe these and other internal terms. Each time the user submits a prompt, the knowledge base 147 can be provided to assist the LLM with the context that is appropriate for the company. The knowledge base 147 can provide information similar to a semantic graph, by describing entities and their relationships. In some cases, the information in the knowledge base 147 can be derived from a semantic graph 150 and then converted into text (e.g., unstructured, semi-structured, or structured) in a format that can be processed by the LLM.

In general, the knowledge base 147 or other additional data set can include data that maps terms or phrases to their meanings. In many cases, this can include semi-structured data or explanatory content, as a way to explain entities and relationships wo the AI/ML models 132. Although the knowledge base 147 may include definitions, more generally the information may include descriptions of people, roles, business units, products, and other terms that may be referenced. The administrator 103 may upload one or more of additional data sets and specify which additional data sets, if any, should be used to provided context for a chatbot. The data sets selected for this contextual function can then be used to provide context for all prompts and responses of the chatbot.

In some implementations, the contextual data sets or knowledge bases can be applied so that they apply to multiple chatbots. For example, an enterprise can designate one or more knowledge bases 147 as contextual data sets that can be applied consistently across the enterprise, for all chatbots created and used in the enterprise. Similarly, different departments within the enterprise may add their own particular contextual data sets that may supplement the enterprise-wide knowledge bases 147. In addition, specific contextual data sets can be added for specific chatbots. In this way, chatbots at different levels of an organization can inherit a consistent set of terminology and knowledge in an organization, which also makes maintaining the overall knowledge base much more simple. The knowledge bases 147 can additionally or alternatively be specified with a scope that corresponds to a computing environment, so that chatbots associated with a particular domain or server inherit the knowledge bases for that domain or server.

One of the advantages of the knowledge base 147 is consistency for many users and even for many different chatbots of an organization. The user submitting a prompt does not need to take any action to select or include the knowledge base 147 in the chatbot's processing, the chatbot automatically include the knowledge base 147 in its context for each prompt or question received. Also, because the knowledge base 147 can be shared or inherited by many chatbots within an organization, updating and maintaining the knowledge base 147 is simple. An edit to the knowledge base 147 is automatically applied to all of the chatbots associated with the organization, even if the chatbots were created by different administrators or provided to different sets of users.

In addition, the knowledge base 147 provides persistent context that is not lost from one prompt to another or from one session to another. The knowledge base content can also be implemented applied in a manner that the knowledge base 147 does not count toward the instruction token limits that the AI/ML models 132 consume for each response. Rather than counting toward the tokens for prompts and recent history, the knowledge base 147 can be accessed or provided to the AI/ML models 132 as a separate source of knowledge apart from the prompt and context, and so does not count toward the token limits of an LLM. Implementations of access to the knowledge base 147 can vary. For example, when a session with the chatbot is instantiated, the knowledge base can be provided as part of initializing the chatbot. In some cases, the AI/ML models 132 are additionally or alternatively configured to access the primary dataset and if the user prompt includes a term or makes a request for an item not specified in the primary dataset, the chatbot is configured for the AI/ML models 132 to then check the knowledge base or other contextual data sets. In some implementations, the knowledge base 147 can be prepared as an embedding, a vector database, or other format that can be accessed by or referred to by the AI/ML models 132.

With the additional knowledge chatbot has three general sources of information before even receiving the user prompt. First, the chatbot has the primary dataset (e.g., data set A 122a) selected by the administrator 103, which is the primary source of answer for the chatbot. Second, the chatbot has a set of instructions that the administrator 103 provided, e.g., general instructions such as the description of the primary dataset, the purpose of the chatbot, the type of user or type of task interacting with the chatbot, and a description of how the chatbot should form responses (e.g., response format, types of data to include, order of elements to include, etc.). Third, the chatbot has the knowledge base, which provides additional context behind the purpose of the bot and how the customer defines things. These types of information form a base level of information that is available for all users that use the chatbot. Also, for each user, the chatbot receives the user's prompt and also receives information about the conversation history of the user (e.g., previous queries and responses, from the current session and/or prior sessions).

In some implementations, the chatbot is designed to have a long-term memory 148, which can store information learned from users in past interactions. For example, LLMs and other AI/ML models 132, on their own, are generally stateless and do not natively understand the user context or history of interactions with the user, especially from previous sessions. The computer system 110 can facilitate learning by the chatbot to provide infrastructure that creates a long-term memory 148 for the chatbot. For example, the long-term memory 148 can store items such as definitions of terms for a particular user context, unique text elements the chatbot might encounter, and feedback from prior user interactions.

One valuable aspect of the long-term memory 148 is the ability for the chatbot to learn and adapt from explicit or implicit user feedback over time. If a user asks questions, then gives feedback they were expecting something different (e.g., either through text of a prompt to the chatbot or through an external survey or rating), then the computer system 110 can capture that feedback and update the chatbot to better provide what the user intended in the future. For example, the computer system 110 may add or adjust the instructions to the chatbot to reflect the user expectations or preferences. In some cases, this may include changing the default response format or response instructions, or may include adding rules or explanations that are context-dependent (e.g., apply to specific phrases or prompt types). This learning may occur at different levels. For example, it may include learning that particular terms, phrases, or combinations of terms call for a particular type of response. As another example, the feedback may more shift answers generally in certain ways, e.g., to be more verbose, more concise, to add or change visualizations, to change the order of content, to add or adjust summary elements, and so on.

The learning of the chatbot is managed by the computer system 110 and happens on an ongoing basis as users interact with the chatbot. The information learned is stored outside the LLM or other AI/ML models 132, and is stored in the long-term memory 148 designated for the chatbot. Each chatbot that is created can have its own long-term memory 148, which is updated by the interactions of its own users. Before the computer system 110 asks the stateless LLM to provide a response to a user prompt, the computer system 110 facilitates retrieval of data from the long-term memory 148, potentially to provide customized instructions or additional contextual data to accompany the user prompt and tailor the response based on what has been learned from prior interactions. The long-term memory 148 thus provides better reference data for LLM to use in guiding answer generation.

The long-term memory 148 can include business definitions of other users have specified or uploaded. In this way, the long-term memory 148 can supplement or expand on the descriptions provided in the knowledge base 147. The chatbots can be configured to learn at different levels, e.g., at the level of individual users, at the level of a department or group of users, and for an enterprise as a whole. In other words, the preferences of an individual may be learned and applied for that individual. In addition, the aggregate preferences learned for many individuals can be combined to also adjust the chatbot, to accelerate the adaptation of the chatbot to meet the needs of the user base. In some implementations, the computer system 110 can use access control lists and permissions for users to apply security policies to adjust access and appropriately set the context for each user.

In stage (D), the computer system 110 provides access to the chatbot to various users. 105a-105c. For example, the chatbot settings 144 specified by the administrator 103 can specify access control parameters that indicate groups of users or individual users or categories of users who receive access to the new chatbot. The computer system 110 provides access to the chatbot to authorized users in any of various ways. For example, the computer system 110 can send a message to authorize users with a URL or other link to web page, web application, or native application functionality providing the chatbot interface. As another example, the computer system 110 can update and interface such as a document library, dashboard, or other user interface to include a panel with the chatbot interface, or to include an icon, button, or other control that is interactive so that users can interact to request that the chatbot interface be provided.

Referring to FIG. 1C, after the chatbot has been customized and saved, a user 105c interacts with the chatbot. For example, the user 105c accesses a user interface 162 for the chatbot. The user interface 162 includes a field in which the user can enter a question or other user prompt 170. In the example, the user 105c enters the prompt 170, and the user's client device 106c sends the prompt 170 to the computer system 110 for processing. The computer system 110 receives the prompt 170 and begins a series of interactions used to generate the response to the prompt 170.

As discussed above, the chatbot has an associated knowledge base 147 that can include, for example, descriptions of terms that may have a unique meaning in the particular context of the user. The knowledge base 147 may be shared by multiple chatbots or even all chatbots associated with the company or organization of the user. When the computer system 110 establishes a new session of the chatbot and a user, the computer system 110 can provide the knowledge base 147 as part of initializing the session with the AI/ML model 132. As a result, the knowledge base 147 can provide additional context for all of the subsequent interactions with the AI/ML model 132.

In addition, the chatbot has information in its long-term memory 148 that has been learned through previous interactions with users. This information can be provided upon initialization of the chatbot, as the knowledge base 147 is, or can be provided in other ways. For example, the information from the long-term memory 148 can be selectively and contextually applied, as the computer system 110 analyzes the prompt 170 and determines whether there is information in the long-term memory 148 that is relevant to the content of the prompt 170. The retrieved content of the long-term memory 148 that the computer-system 148 determined to be relevant to the prompt, can then be provided with the prompt 170. As another example, certain information in the long-term memory 148 may be applicable to a specific user, role, or permission level, and the computer system 110 can provide that information in response to determining that the user 105c submitting the prompt 170 is that user or has that role or permission level. In other cases, the information in the long-term memory 148 supplements or alters the general instructions or initialization commands for starting the chatbot session, either in all cases or selectively when specific prompt content or user context is detected.

In stage (F), the computer system 110 generates and sends a first request 172 to the AI/ML service provider 130. The first request 172 includes the prompt 170 and information about the dataset 122a, and represents a request for an AI/ML model 132 to generate instructions for answering the prompt 170. For example, rather than asking the AI/ML model 132 for the answer to the prompt 170, the first request 172 can request a SQL statement, programming code, a list of operations, or other instructions that specify how to retrieve or calculate and answer to the prompt 170. As a simple example, the prompt to the LLM in the first request 172 may include an instruction such as “provide a SQL statement that retrieves the data needed to answer the question <<user prompt>>,” or “generate Python code that can run on <<database system>> to calculate the answer to the question <<user prompt>>.” The content of the first request 172 can be designed for the particular AI/ML model 132 and its capabilities.

As a result, the first request 172 can be a request for a SQL statement or Python code that, when interpreted or executed by another system such as the database system 120, will cause the other system to retrieve and/or generate a focused subset of data (e.g., a result data set) from the data set 122a that can be used to answer to the prompt 170 from the dataset 122a. The first request 172 can also include one or more custom instructions that the administrator 103 specified, to further orient the AI/ML model 132 to generate data processing instructions that are most applicable for the tasks, situations, purposes, or users that the chatbot is designed for. In some cases, one or more custom instructions are appended or otherwise included with the user prompt 170 in the first request 172.

Many AI/ML models 132, such as LLMs, operate in a substantially stateless manner, in which a general model 132 does not automatically include context of previous interactions or specific knowledge about the chatbot being used. In addition, the chatbots provided by the computer system 110 do not need to have a one-to-one relationship with the AI/ML models 132. For example, a single model 132 may serve as the model for many different customized chatbots that are created and hosted using the computer system 110. Creating and customizing a chatbot does not require training or updating an AI/ML model 132, and instead can define parameters of the chatbot experience that are separate from the AI/ML model 132 (e.g., LLM) itself (e.g., parameters such as the data set used, the custom instructions provided with user prompts, whether Internet data can be used, the format and preferences for answers, and so on).

In order for the AI/ML model 132 to be able to appropriately answer the first request 172 and provide data processing instructions to answer the prompt 170, the computer system 110 can include with the request 172 information about the dataset 122a and the database system 120. For example, the first request 172 can include metadata about the structure and contents of the dataset 122a, without including actual data of the dataset 122a. For example, the metadata may include a database schema, a description of the dataset structure, a description of semantic, meaning of the tables, columns, and other elements of the dataset, and so on. The request 172 may also include sample data, such as a few rows of data or fictitious computer-synthesized data that is of the same type and structure as the dataset 122a, but does not include the actual values from the dataset 122a.

For example, the first request 172 can indicate the types of data in the dataset 122a, and include a sample row or rows of data from the dataset 122a. The request 172 can also include information about the capabilities of the database system 120 and the data processing functions and manipulations that are available. For example, the request 172 can include instructions or description how to interact with the database system 120 to perform various processing functions, such as commands for sorting, filtering, joining, and otherwise manipulating data. In some cases, this information may include text of a user manual or other human-readable text describing the use of the database system 120. As another example, the request 172 can include a table of available commands for manipulating data in the database system 120, an API description for the database system 120, a list of valid interactions and their effects, or other data.

The first request 172 can be generated or adjusted based on information in the long-term memory 148 or other information about the user. For example, given the user interactions or feedback received through prompt-response cycles with the user 105c and/or other users, the long-term memory 148 may include information that can clarify what users intend when they ask a question as indicated in the prompt 170. For example, the long-term memory may specify that a visualization should be included, or that data should be ordered in a particular way. In addition, the computer system 110 also stores information about the user 105c and his current context, represented as user context data 156. This user context data 156 can indicate, for example, the identity of the user, permissions of the user, a device type of the user's device 106c, a location of the user, a role of the user, a department of the user, and so on. In addition, the computer system 110 stores conversation histories 157 of users that have previously interacted with the chatbot. As a result, information about previous prompts from the user 105c and previous responses, in whole or in part (e.g., in summary form) and from the current session and/or previous sessions, can be retrieved and used to supplement the prompt 170. The computer system 110 can provide the user context data 156 and conversation history 157 for the user 105c in or with the request 172, so the AI/ML model 132 can generate data processing instructions with the context of the user's situation and previous conversations, which may better explain or help disambiguate the most recent prompt 170.

In stage (G), the AI/ML service provider 130 uses the AI/ML models 132 to generate a response to the first request 172. The AI/ML service provider 130 then sends the response, a set of data processing instructions 174, to the computer system 110. As discussed above, the first request 172 requests instructions specifying the processing operations that the database system 120 can use to retrieve and/or generate (e.g., calculate) from the dataset 122 the result data that would be needed to answer the user prompt 170. As a result, the AI/ML service provider 130 uses the AI/ML models 132 to generate the data processing instructions 174 that, when executed by the database system 120, will retrieve and/or generate the data needed to answer the prompt 170. In this process, the system 100 leverages the ability of the AI/ML models 132, e.g., LLMs, to generate a set or sequence of instructions or operations. The data processing instructions 174 can be expressed in any of a variety of ways, such as one or more SQL statements, as executable or interpretable code, such as Python code, as a list of API calls or commands to be executed, and so on.

In stage (H), the computer system 110 uses the received data processing instructions 174 to instruct the database system 120 to obtain (e.g., retrieve, calculate, generate, etc.) the data needed to answer the user prompt 170. For example, the computer system 110 may send a request that includes the data processing instructions 174 to the database system 120, in order to request the needed data. In some implementations, the computer system 110 may apply a set of rules or validation checks to verify that the data processing instructions 174 are valid and appropriate to be executed by the database system 120. For example, the computer system 110 can store rules or heuristics 152 that can evaluate the data processing instructions 174 element by element and/or as a whole to verify and correct the data processing instructions 174 if needed before they are sent to the database system 120. In some implementations, the computer system 110 uses the rules or heuristics 152 to convert or transform the data processing instructions 174 from one format or type to another.

When interacting with the AI/ML service provider 130 and/or the database system 120, the computer system 110 can apply the customized settings and properties that the administrator 103 defined for the chatbot. For example, the administrator 103 can limit which portions of the dataset 122a can be accessed by the chatbot, and so the computer system 110 can apply those limits so that the first request 172 to the AI/ML service provider 130 does not reference omitted data (e.g., excluding from the description of the data set 122a columns or tables that are not to be referenced, so the AI/ML models 132 cannot use them or even determine that they exist). Similarly the first request 172 can include instructions to specifically exclude or avoid using certain data. In addition, or as an alternative, the computer system 110 can filter, edit, or otherwise check the data processing instructions 174 so that the operations specified do not draw from or become calculated based on excluded data. In addition, or as an alternative, the computer system 110 can analyze the results 176 to verify that the results 176 do not include or are not based on the excluded data.

As another example, the computer system 110 can apply access control policies or custom behavior based on the identity or role of the user 105c issuing the prompt 170. Those custom behaviors can be reflected in the interactions of the computer system 110 to the AI/ML service provider 130, such as in the request 172, as well as in the interactions with the database system 120.

In stage (I), the database system 120 generates and sends results 176 that include the data retrieved from and/or generated based on applying the data processing instructions 174 for the dataset 122a. The database system 120 processes or executes the data processing instructions 174 that it receives, which creates the results 176, which may be in any of various forms, such as records retrieved, data series, aggregations of data, statistics about data in the dataset 122a, subsets of the dataset 122a determined to be relevant, and so on.

In the illustrated example, the user prompt 170 asks which regions have the greatest revenue over the last year. The data processing instructions 174 generated by the AI/ML models 132 specify the operations needed to generate measures of revenue by region for the previous year. For example, the data processing instructions 174 may include a SQL statement to retrieve these values, or may include a set of instructions in a programming language, such as Python. The results 176 generated by the database system 120 include the values needed to answer the question in the user prompt 170. In other words, the results 176 include values of revenue for the regions specified in the dataset 122a, appropriately labeled or associated with identifiers for those regions. In this process, the AI/ML models 132 have been leveraged to obtain the results 176, however, the AI/ML models 132 did not need or receive access to the dataset 122a itself, and the AI/ML models 132 did not incur the resource costs of having to process the dataset 122a. In addition, the database system 120 and its reliable, repeatable calculations ensure that the results 176 are accurate, without the AI/ML models 132 introducing uncertainty into the calculations.

In addition, the dataset 122a may be very large, much larger than the maximum context length of an LLM used for the AI/ML model 132. In many cases, the amount of data in the dataset 122a may be orders of magnitude larger than the maximum context size that the LLM can process. The database system 120 can process a large dataset much more quickly and with greater power efficiency than an LLM can. Due to limits on LLM context sizes, it may be impractical or impossible for an LLM to analyze the dataset 122a to generate the needed results 176.

In stage (J), the computer system 110 sends a second request 178 to the AI/ML service provider 130. The second request 178 includes the results 176 and requests that the AI/ML models 132 generate a summary or other text response that answers the prompt 170 based on the results 176. For example, the second request 178 may be a request to answer the prompt 170 using the data in the results 176 as context. As another example, the second request 178 may be a request for the AI/ML models 132 to summarize the results 176, in addition to or instead of answering the user prompt 170. The second request 178 can also include one or more custom instructions that the administrator 103 specified, to further orient the AI/ML model 132 to respond in the format and with the content that is most applicable for the dataset 122a and/or the overall purpose for which the chatbot was designed (e.g., customization for a particular organization, set of users or user roles, set of tasks, etc.). In some cases, one or more custom instructions are appended or otherwise included with the user prompt 170 in the second request 178.

As with the first request 172, the computer system 110 can provide the user context data 156 and conversation history 157 for the user 105c in or with the second request 178, so the AI/ML model 132 can generate a response based on the context of the user's situation and the user's previous conversations, which may better explain or help disambiguate the most recent prompt 170. The computer system 110 can also provide information from the long-term memory 148 that the computer system 110 determines to be relevant, potentially as determined to be relevant specifically to the user 105c, the user context data 156, and/or the prompt 170.

In some implementations, the chatbot is configured to generate visualizations as part of the response to a user prompt 170. To create these visualizations, the computer system 110 can include in the second request 178, or as an additional request, a request for the AI/ML models 132 to indicate an appropriate type and format of visualization for the response to the request 178. The AI/ML models 132 can then be used to specify the parameters for the visualization, such as the type of visualization (e.g., line chart, bar chart, line graph, geographical map, heat map, etc.), and identification of which data items are shown on different axes or dimensions of the visualization, the ranges to show, the labels to use, the color scheme, and or other properties.

In stage (K), the AI/ML service provider 130 uses the AI/ML models 132 to generate a response to the user prompt 170, e.g., a summary 180 of the results 176 or other response requested by the second request 178. For example, the second request 178 may include or provide access to the results 176 and the user prompt 170, and so the AI/ML models 132 answer the prompt 170 from the context provided by the results 176. In some implementations, this may be a summary of the results 176 and/or may include values extracted from the results 176 with added text description generated by the AI/ML models 132.

For example, in the illustrated example, the AI/ML models 132 indicate the specific regions having the greatest revenue, as requested by the prompt 170, along with an indication of the revenue values taken from the results 176, along with other description and contacts. If the request 178 requests information about a visualization, or if the AI/ML models 132 determine that a visualization is likely appropriate or beneficial, then the summary 180 can include a visualization description. The visualization description can specify the properties recommended for a visualization of the results 176 as a whole, or for specific items that answer the user prompt 170.

In stage (L), the computer system processes the summary 180, and generates and sends a response 182 as the answer of the chatbot to the user prompt 170. The response 182 is then displayed on the user interface 162 of the client device 106c. The computer system 110 can process the summary 180 to create the response 182, for example, by applying customized settings or policies specified in the saved chatbot configuration data 146. In this way, the computer system 110 can apply customized style, formatting, content preferences or restrictions, and other customizations that were defined by the administrator 103. In addition, or as an alternative, the computer system 110 can incorporate those customizations when making the request 178. For example, the computer system 110 may include in the request 178 preferences for a concise or verbose answer, the tone or style of text used, and other preferences.

When a visualization is requested by the prompt 170 or suggested by the AI/ML models 132, the computer system 110 uses the visualization description from the AI/ML models 132 to generate the actual visualization content. In this manner, the visualization that is provided is based on reliable, accurate data or calculations in the results 176 and/or the dataset 122a. For example, the visualization that is rendered has the type of data specified by the AI/ML model 132, and in the arrangement specified by the AI/ML models 132, but with values or data series shown being determined through data retrieval and/or calculations of the database system 120 to ensure accuracy and reliability.

Through any and all of the interactions of the computer system 110 to generate and provide the response 182, the computer system 110 applies the settings and properties specified in the saved chatbot configuration data 146. As a result, the behavior and characteristics that the administrator 103 specified for the chatbot can be enforced at any or all stages of the process to provide the customized interface and chatbot behavior that the administrator 103 desired.

FIG. 2A shows additional detail of an example implementation of the agent 190.

The agent 190 includes an input processor 202 that is configured to gather and organize input, including a user prompt. In addition, the agent 190 can receive a user identifier for the user that is authenticated to the system. The input processor 202 can cause a request for information about the user, such as the permissions of the user and the set of chatbots the user is authorized to access. In this process, the input processor 202 can communicate with authentication modules, to obtain information from access control lists and other data sources.

The agent 190 includes a chatbot selector 192 that has the primary function of selecting which chatbots should be sent the current user prompt. As discussed above, the agent 190 can operate initially in a learning mode, when the selection of chatbots is less selective and questions may be purposefully asked to a broad set of chatbots, even chatbots that may not be relevant for answering the current prompt.

After learning from many observed prompt and response pairs, for many different chatbots and users and prompt examples, the chatbot selector 192 can route user prompts much more selectively. For example, for each prompt, the chatbot selector 192 can select a subset of available chatbots for a user, based on predictions that the chatbot selector 192 makes. The chatbot selector 192 can include a machine learning model 206 that captures the information learned about capabilities of chatbots, preferences of users, and so on. The machine learning model to a six can be repeatedly and incrementally trained or updated based on the agents own evaluation of the quality of responses as well as based on the user feedback provided for chatbot responses. The machine learning model 206 can be, for example, a deep neural network, a classifier, a decision tree, a support vector machine, or other type of machine learning model. The agent 190 can store learned information in other forms. For example, a set of learned preferences 204 can be stored, with a history of user interactions and user feedback or statistics about user actions and user feedback. This information can be used in addition to or instead of the machine learning model 206 to make predictions about the appropriateness or suitability of different chatbots for a given prompt and its associated context.

The agent 190 includes a request generator 193 that generates and sends requests 112 to the chatbots selected by the chatbot selector 192. After a chatbot is selected as appropriate for generating a response to the current prompt, the request generator may generate an appropriate data package or set of context that formulates the request to the chatbot. This can include, for example, adding additional context information, adding domain knowledge, customizing the request for each individual chatbot, specifying data types or output formats to be used, and so on.

After the requests, 112 are sent to the chatbots, the chatbots provide responses 114, which are processed by response processor 194. The response processor 194 can perform operations including analyzing and filtering the received responses 114. For example, the response processor 194 can assign scores to the response is 114 based on various criteria, such as quality relevance to the topic of the prompt, and so on. The response processor 194 can select one or more of the responses 114 that meet at least a minimum quality threshold.

In some implementations, the response processor 194 can identify the occurrence of various patterns or phrases in the responses 114 from the chatbots. For example, response patterns indicative of failure or inability of the chatbot to properly respond can be detected, and the responses exhibiting those patterns can be filtered so they are not shown to the user. To facilitate this, the agent 190 can store a set of sample failure response patterns 210 having the grammars, phrases, or other content that, when present indicates failure of a chatbot to provide a valid answer. The response processor 194 can also compare responses 114 from different chatbots to validate the answers and evaluate the consistency among the set of responses 114.

The agent 190 then uses the highest quality responses 114 to generate the agent response 182 as the response to the prompt that the user will see. The output generator to 112 can perform various operations to generate the response 182, including to select content from the high quality responses 114, to order the content of different responses 114, to combine content of different responses, or to summarize or rephrase chatbot responses 114.

In some implementations, the agent 190 stores a prompt and response cache 195 which stores recent prompts received and corresponding responses generated For the prompts. The input processor 202 can compare received user prompts with those of the prompts in the cache 195. For example, the input processor 202 can perform a semantic comparison, such as using embeddings of various prompts in a vector space or vector database to assess the overall similarity and meaning or topic. As another example, the computer system 110 can interpret the prompts and compare the types of data or data processing criteria to identify a match. For example, prompts that call for the same metrics, attributes, filter criteria, or other data selection criteria may be considered to be equivalent, even if the natural language wording of those requests differs. When the input processor 202 identifies a match with a prompt indicated by the cache 195, the input processor 202 can send an indication of this to the response processor 194, which in turn can retrieve and use the cast response for the previous prompt that is similar. In this case, the agent 190 can omit the steps of sending requests to chatbots and receiving responses 114 from chatbots, because a response is already present in the cache 195.

In some implementations, a answering a user prompt may involve multiple steps or stages of processing which may involve a series of requests to chatbots. For example, the response processor 194 or output generator 212 may identify that additional information is needed to fully answer the prompt 111. The input processor 202 or another component can determine even before sending requests 112 that multiple rounds of interaction will be needed to answer the prompt. In these cases, operations represented for the agent 190 can be performed multiple times, once for each of the stages or steps needed to answer the prompt. For example, a first set of requests 112 and responses 114 can be used to generate a first component of an answer or a first set of intermediate data, which may then be provided in a subsequent set of requests 112 to obtain additional responses 114 in a second round of interactions. Thus, the agent 190 can iteratively generate a final answer to a prompt through multiple rounds of querying chatbots and receiving responses.

As another example, after selecting a subset of chatbots to answer a prompt, the response processor 194 may determine that none of the responses 114 received from the subset provide an appropriate response. As a result, the response processor 194 can send that information to the model selector 192 so that the model selector 192 can select a different subset of chatbots and send requests to a different or broader set of chatbots and increase the likelihood of obtaining a valid answer.

In some implementations the use of multiple steps or stages of querying chatbots can be used to assemble answers across domains of multiple chatbots. For example, the system may ask one chatbot to obtain an answer for a first step or to provide a first type of information, and then the system can perform another round of querying chatbots to obtain a different type of information from a chatbot that has access to a different data set.

FIG. 2B shows an example of the agent 190 learning over time by updating the machine learning model 206. As more queries are provided by users and answered by chatbots, the agent 190 receives information about failures of chatbots to answer prompts, the agent 190 generates its own quality scores for responses, and the agent receives user interaction data about user actions in response to different responses. The agent 190 uses these sources of information to train the machine learning model 206 to better predict, based on the content of the prompt and the associated context, which chatbots will produce high quality responses. The machine learning model 206 or other predictive functionality can potentially use other factors in making its predictions, such as the identity of the user, a role or department of the user, and so on.

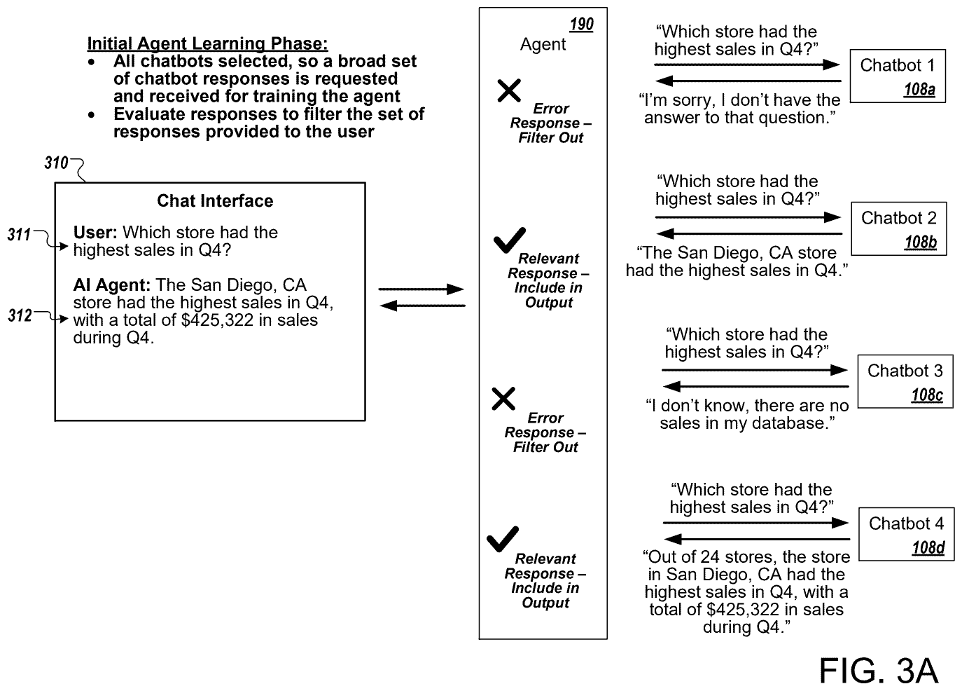

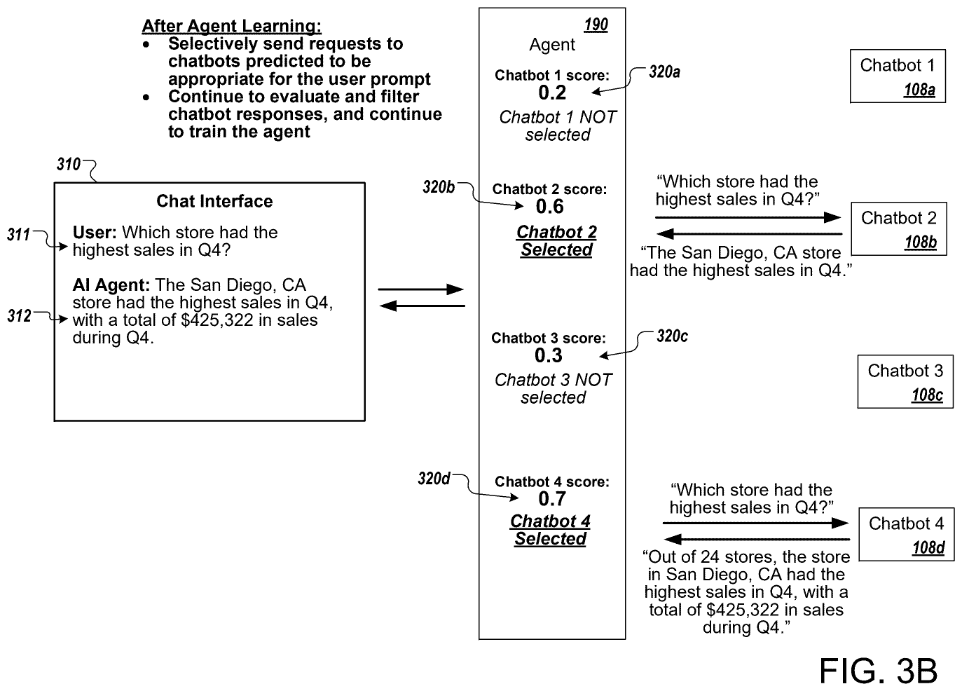

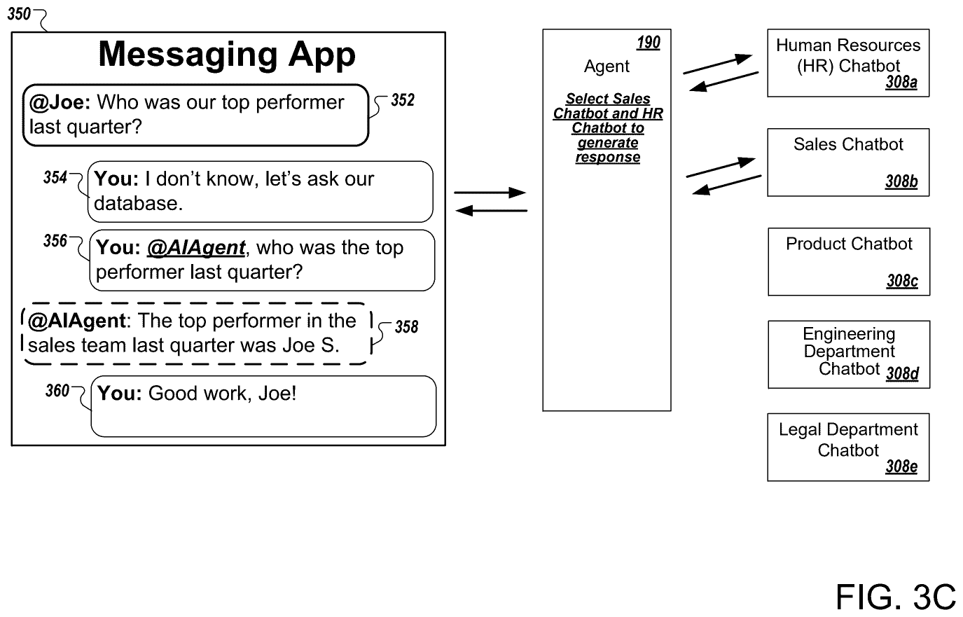

FIG. 3A is an example of the agent 190 being used during an initial learning phase. In this example, because the agent 190 is operating in the learning phase, the agent 190 selects all available chatbots to respond to each user prompt. As a result, a broad set of chatbot responses is requested and received in order to obtain data for training the agent 190. The agent 190 evaluates responses from the various chatbots 108a-108d to determine the response 312 to provide to the user.

In further detail, the user is provided a chat user interface 310, and the user enters a prompt 311 in response, the agent 190 sends the prompt 311 to each of the chatbots 108a-108d. Of these chatbots, the chatbot 108a and the chatbot 108c each provide responses that indicate a failure to answer the question. For example, the chatbot 108A states, “I'm sorry I don't have the answer to that question,” and the chatbot 108c states, “I don't know, there are no sales in my database.” As a result, the agent 190 classifies these responses as each representing an error or a failure to respond appropriately, and so the agent 190 filters out these responses so they are not shown to the user.

The agent 190 evaluates the responses from the chatbot 108b and the chatbot 108d and classifies these responses as valid or appropriate. As a result, the agent 190 provides the content of those responses in the response 312 shown to the user. In particular, both of the responses from the chatbot 108b and the chatbot 108d provide useful information. Here, the agent 190 determines that the two responses are consistent, in that they both agree that the San Diego, CA store had the highest sales. Nevertheless, the response from the chatbot 108d provides additional information about the amount of sales. As a result, agent 190 can select the more complete answer of the chatbot 108d, or in this case, combine the concise and direct answer from the chatbot 108b with the additional information about the sales amount from the response of the chatbot 108d.

FIG. 3B shows another example of the chatbot 190, this time being used after the learning phase is complete. In this example, the agent 190 selectively sends requests to chatbots that are predicted to be appropriate for the current user prompt. The agent 190 continues to evaluate and filter chatbot responses, and the data gathered is used to continue to train the agent 190.

In this example, the user again accesses the chatbot interface 310 and submits a prompt 311. The agent 190 receives the prompt 311, and based on the prompt 311 the agent 190 generates scores 320a-320d indicating predicted likelihoods that different chatbots 108a-108d will be appropriate to answer this prompt 311. The chatbots 108b and 108d have the highest scores, and so these chatbots are selected. The chatbots 108a and 108c have low scores (e.g., scores below a minimum threshold), and so are not selected to respond to this prompt 311. The agent 190 sends a request to the chatbot 108b and the chatbot 108d, and not the others. The agent 190 then uses the responses from these chatbots 108b, 108d to generate the response 312 that is sent to the user's device and displayed in the chat interface 310.

FIG. 3C shows another example in which the agent 190 is used to identify an appropriate set of chatbots to respond to a prompt. This example shows integration of the chatbot system and the agent 190 with a messaging application. For example, a messaging user interface 350 can provide users the ability to send messages to each other. The messaging interface 350 also supports chatting with the agent or other chatbots. For example, the interface 350 shows an example where a message 352 from a first user named Joe is followed by a message 354 from a second user. Then, a message 356 issued by the second user identifies the agent 190 and invokes the agent 190 to answer the question. This can be done by, for example, including a keyword or identifier, in this case “@AIAgent.” This signals to the computer system 110 that the question should be directed to the agent 190, which in turn can automatically select from among the full set of chatbots 308a-308e that are available to the user asking the question. In some implementations, the agent 190 identifies all of the users participating in the conversation in the interface 350, and only uses chatbots or data sets that are available to them all. In this way, the system can help enforce data access control policies and limitations so that one user does not post to the group information that at least some members of the group are not authorized to receive.

In the example, the question for the agent 190 is “who is the top performer last quarter?” The agent 190 identifies the human resources chatbot 308a and the sales chatbot 308b as most relevant for that question. As a result, the agent 190 selects the two chatbots 308a, 308b to provide responses, and the agent 190 sends the question in the message 356 to each of the two chatbots 308a, 308b. The chatbots 308a, 308b each provide their respective responses to the agent 190, which provides the response as message 358.

As the example shows, the system can monitor for the presence of keywords or other references that invoke the agent 190, and then the system can cause the agent 190 to respond with messages in a messaging platform similar to the way another user might respond. Because the agent 190 has access to many chatbots and can select from among them and combine their answers, users gain the benefit of the knowledge of many different chatbots through invocation of a single AI agent. Users do not need to know the names or keywords for invoking different individual chatbots for specific types of questions. Of course, the system can still make the individual chatbots 308a-308e available for direct invocation or questioning through a messaging interface 350, with each chatbot 308a-308e having its own name or keyword for directing questions to it specifically when users desire to do so.

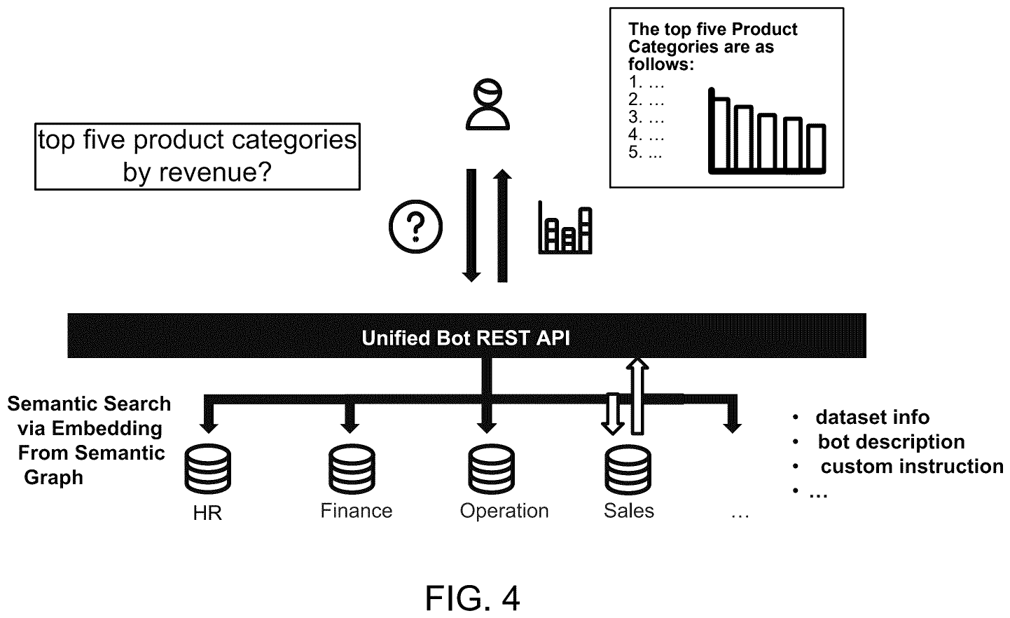

FIG. 4 is another example of the use of an agent 190 to access different chatbots or data sets. For example, the user submits a prompt, top five product categories by revenue. This prompt is sent to a unified chatbot application programming interface API, such as a REST API. Then, the agent 190 or similar functionality can select from among different data sets and/or chatbots to route the question to the appropriate functionality for answering. In some cases, the system can use a semantic search using embeddings from a semantic graph to determine which chatbot or data set is most appropriate. In the example, the sales database and associated chatbot are identified as most appropriate for the prompt. as a result, the system queries the sales database or sales chatbot do you provide an answer. This can include using information about the data set itself, the description of the chatbot, a custom instruction to the chatbot, or other information to retrieve the data needed. In this case, the result includes text and a visualization from the system that provide an answer to the user's prompt.

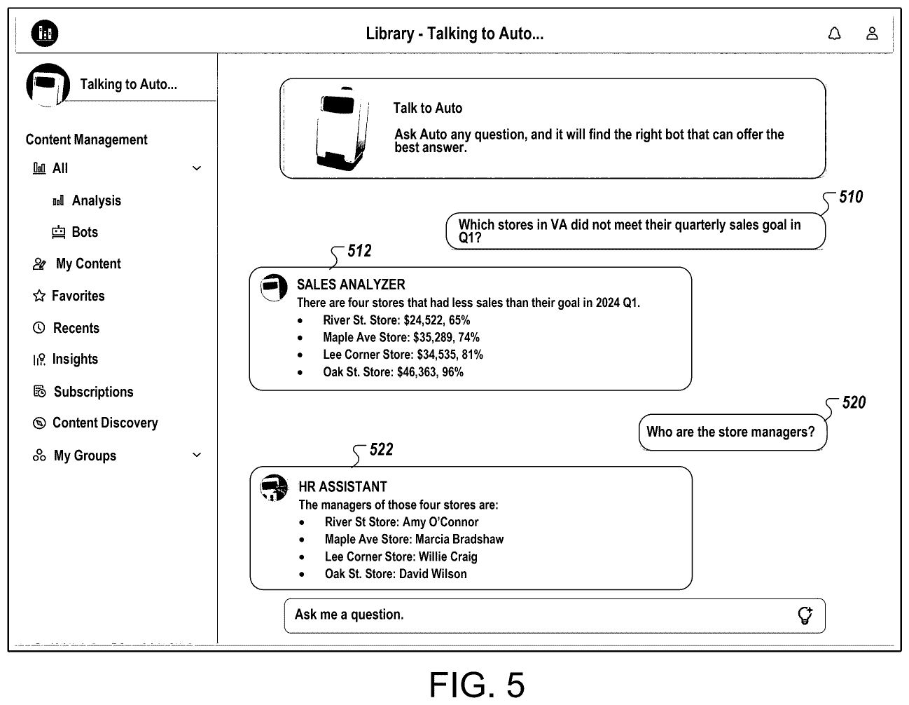

FIG. 5 shows another example of the system providing a unified interface for users to communicate with multiple chatbots. The example shows a user interface 500 in which a user submits prompts 510, 520 to ask questions of a chatbot. The interface shows that the user is talking to a chatbot called “Auto,” which serves as the agent for automatically selecting an appropriate chatbot to answer each prompt 510, 520.

In response to the first prompt 510, the computer system 110, providing the Auto chatbot interface, selects a chatbot called “Sales Analyzer” to provide a response 512. The Sales Analyzer chatbot may be selected based on, for example, a prediction from a machine learning model that indicates that it is the most appropriate for the content of the prompt 510, and/or based on the identity of the particular user, the user's history of chatbot prompts or other actions (e.g., document accesses, SQL queries run, etc.), the user's role or department in an organization, and so on. As another example, the Sales Analyzer may have a profile that indicates metadata about topics, data objects, or keywords that are associated with the Sales Analyzer chatbot and/or the underlying data set(s) this chatbot can provide information about. The computer system 110 can determine that the Sales Analyzer bot is the closest match and so select this chatbot to answer the prompt 510. As another example, the computer system 110 can send the prompt 510 to multiple chatbots to answer, and then examine the responses and determine that the response 512 from the Sales Analyzer chatbot is most relevant and thus select it to present to the user.

In response to the second prompt 520, the computer system 110 provides a chatbot response 522 generated by a different chatbot, the “HR Assistant.” Although the user prompt 520 continues the conversation and builds on the context established from the previous prompt 510 and response 512, the Sales Analyzer does not have access to the data set specifying employee information. However, the computer system 110 can determine that, for a question about managers or employees, the HR Assistant has access to the needed data set or is most likely to provide the answer. In some implementations, the computer system 110 can send the prompt 520 to multiple chatbots to answer, and then select the response 522 as the most appropriate or most relevant answer, especially if it is the only one that does not result in a failure response (e.g., “I'm sorry . . . ,” “I don't have that information . . . ,” etc.). When sending the prompt 520 to the HR Assistant chatbot, the computer system 110 includes the context of the conversation, e.g., the prompt 510 and response 512, along with the new prompt 520 to be answered. As a result, the HR Assistant receives the context to determine which stores the prompt 520 is asking about, because that information is included in the response 512 that the AI/ML model 132 for the HR Assistant chatbot receives as context for the prompt 520.

In general, the user interface 500 illustrates how the system can provide a single interface for all types of queries or prompts to chatbots, allowing direct access to chatbots for many different data sets (e.g., HR, Finance, Sales, etc.) through a command center in a document library or other interface. The interface can provide cross-platform accessibility, being seamlessly available on both desktop and mobile platforms, as well as through standalone or embedded interfaces, and through native applications or web-based applications or web pages. The unified interface can provide comprehensive answers, by intelligently identifying and retrieving precise information from the correct chatbot, which simplifies the process of the user submitting prompts and relieves the user from having to specify target chatbots to ask or to manually switch between chatbots when access to a different data set is needed.

FIGS. 6A-6B show additional user interfaces that can be used to access chatbots.

For example, as shown in FIG. 6A, the computer system 110 can support integration of the agent 190 in a messaging platform, so a user can carry on a chat with various chatbots through a chat conversation in the messaging platform. FIG. 6A shows a “Library” channel in the messaging platform, for the user to directly provide prompts to and receive responses from chatbots, carrying on conversations with the chatbot(s) just as the user would converse with another user or group of users through another channel or conversation. As the user provides prompts, the computer system 110 uses the agent 190 to route prompts to the appropriate chatbots, preserving the conversation context during the switches between chatbots and also providing suggested prompts (e.g., “forecast profit for the next 30 days,” “what is the average inventory per day?,” “what is the highest profit recorded in a day?”).

FIG. 6B shows another example of integration with a messaging platform, where the user can direct a message to the agent, and thereby access any or all of the available chatbots for the user, in the context of a conversation with one or more other users. For example, here, the agent is invoked by the name “Library.” In the conversation with another user, the user directs a message to the Library, which responds with a message from a selected chatbot, “sales bot,” and the response is provided to all of the users in the conversation.

The integration with chatbots with messaging platforms such as Microsoft Teams, Slack, and others provide access to chatbots and their related data sets where they are collaborating with others. By providing chatbot access through dedicated conversation channels, or by allowing the chatbot(s) to enter in conversations with other users, the system creates a more natural conversational experience.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

1. A method performed by one or more computers, the method comprising:
receiving, by the one or more computers, a text input from a user that is entered at a user device of the user;
identifying, by the one or more computers, multiple chatbots that the user is authorized to access, wherein at least some of the multiple chatbots are configured to answer questions about data from different data sources;
selecting, by the one or more computers, a subset of the multiple chatbots based on the text input from the user, wherein the subset comprises at least one of the multiple chatbots and fewer than all of the multiple chatbots;
providing, by the one or more computers, the text input from the user to each of the chatbots in the subset to generate a response to the text input from each of the chatbots in the subset; and
providing, by the one or more computers, an output response to the text input from the user for presentation at the user device, wherein the response is based on one or more of the responses generated the chatbots in the subset.

2. The method of claim 1, wherein receiving the text input comprises receiving the text input over a communication network at a server system;
wherein each of the multiple chatbots are configured to generate responses using one or more artificial intelligence and/or machine learning models; and
wherein providing the output response to the text input comprises providing the output response from the server system over the communication network to the user device.

3. The method of claim 1, wherein receiving the text input comprises receiving the text input through an application programming interface (API).

4. The method of claim 1, wherein the text input from the user is entered through a messaging interface or a chatbot interface, and wherein the messaging interface or a chatbot interface is configured to selectively provide access to each of the multiple chatbots without the user selecting or specifying which chatbot to interact with.

5. The method of claim 1, wherein the one or more computers are configured to automatically select, for each of multiple user prompts, which of the multiple chatbots to use to respond to the user prompt.

6. The method of claim 1, comprising receiving a series of user prompts in a conversation, and varying which of the multiple chatbots is used to answer the respective user prompts based on content of the respective user prompts.

7. The method of claim 1, wherein the selected subset of the multiple chatbots comprises at least two chatbots; and
wherein the output response is generated based on the responses of each of the at least two chatbots.

8. The method of claim 7, wherein the output response combines information from the responses of the at least two chatbots.

9. The method of claim 7, wherein the method includes generating the output response, including by using one of the responses of the at least two chatbots to verify or validate another of the responses of the at least two chatbots.

10. The method of claim 1, comprising monitoring for subsequent interactions of the user after the output response is provided;
detecting an interaction of the user after the output response is provided; and
adjusting a process of selecting chatbots to respond to user input based on the detected interaction of the user.

11. The method of claim 1, comprising storing a registry of chatbots, including storing an association of each of the chatbots with one or more topics, data sets, data objects, types of data, or keywords; and
wherein selecting the subset of the multiple chatbots comprises selecting the subset of the multiple chatbots based on similarity or relevance of the topics, data sets, data objects, types of data, or keywords associated with the respective chatbots with respect to the text input from the user.

12. The method of claim 1, wherein selecting the subset of the multiple chatbots comprises using a machine learning model to select from among the multiple chatbots.

13. A system comprising:
one or more computers; and
one or more computer-readable media storing instructions that are operable, when executed by the one or more computers, to perform operations comprising:
receiving, by the one or more computers, a text input from a user that is entered at a user device of the user;
identifying, by the one or more computers, multiple chatbots that the user is authorized to access, wherein at least some of the multiple chatbots are configured to answer questions about data from different data sources;
selecting, by the one or more computers, a subset of the multiple chatbots based on the text input from the user, wherein the subset comprises at least one of the multiple chatbots and fewer than all of the multiple chatbots;
providing, by the one or more computers, the text input from the user to each of the chatbots in the subset to generate a response to the text input from each of the chatbots in the subset; and
providing, by the one or more computers, an output response to the text input from the user for presentation at the user device, wherein the response is based on one or more of the responses generated the chatbots in the subset.

14. The system of claim 13, wherein receiving the text input comprises receiving the text input over a communication network at a server system;
wherein each of the multiple chatbots are configured to generate responses using one or more artificial intelligence and/or machine learning models; and
wherein providing the output response to the text input comprises providing the output response from the server system over the communication network to the user device.

15. The system of claim 13, wherein receiving the text input comprises receiving the text input through an application programming interface (API).

16. The system of claim 13, wherein the text input from the user is entered through a messaging interface or a chatbot interface, and wherein the messaging interface or a chatbot interface is configured to selectively provide access to each of the multiple chatbots without the user selecting or specifying which chatbot to interact with.

17. One or more non-transitory computer-readable media storing instructions that are operable, when executed by one or more computers, to perform operations comprising:
receiving, by the one or more computers, a text input from a user that is entered at a user device of the user;
identifying, by the one or more computers, multiple chatbots that the user is authorized to access, wherein at least some of the multiple chatbots are configured to answer questions about data from different data sources;
selecting, by the one or more computers, a subset of the multiple chatbots based on the text input from the user, wherein the subset comprises at least one of the multiple chatbots and fewer than all of the multiple chatbots;
providing, by the one or more computers, the text input from the user to each of the chatbots in the subset to generate a response to the text input from each of the chatbots in the subset; and
providing, by the one or more computers, an output response to the text input from the user for presentation at the user device, wherein the response is based on one or more of the responses generated the chatbots in the subset.

18. The one or more non-transitory computer-readable media of claim 17, wherein receiving the text input comprises receiving the text input over a communication network at a server system;
wherein each of the multiple chatbots are configured to generate responses using one or more artificial intelligence and/or machine learning models; and
wherein providing the output response to the text input comprises providing the output response from the server system over the communication network to the user device.

19. The one or more non-transitory computer-readable media of claim 17, wherein receiving the text input comprises receiving the text input through an application programming interface (API).

20. The one or more non-transitory computer-readable media of claim 17, wherein the text input from the user is entered through a messaging interface or a chatbot interface, and wherein the messaging interface or a chatbot interface is configured to selectively provide access to each of the multiple chatbots without the user selecting or specifying which chatbot to interact with.
